(19) United States
(12) Patent Application Publication
(10) Pub. No.: US 2018/0043389 A1
(43) Pub. Date: Feb. 15, 2018

(54) MULTIFUNCTIONAL COATING SYSTEM AND COATING MODULE FOR APPLICATION OF CATALYTIC WASHCOAT AND/OR SOLUTION TO A SUBSTRATE AND METHODS THEREOF

(71) Applicant: BASF CORPORATION, FLORHAM PARK, NJ (US)

(72) Inventors: Gary A. Gramiccioni, Madison, AL (US); Kenneth R. Brown, Athens, AL (US); Erik C. Nielsen, Huntsville, AL (US)

(73) Assignee: BASF CORPORATION, FLORHAM PARK, NJ (US)

(21) Appl. No.: 15/557,513

(22) PCT Filed: Mar. 28, 2016
(86) PCT No.: PCT/US2016/024511

§ 371 Date: Sep. 12, 2017

Related U.S. Application Data
(60) Provisional application No. 62/140,103, filed on Mar. 30, 2015.
(60) Provisional application No. 62/140,205, filed on Mar. 30, 2015.

(51) Int. Cl. B05C 7/04; B05C 9/10; B01J 37/08; B01J 35/04; B01J 37/02; B05C 9/14; F26B 21/00

(52) U.S. Cl. CPC B05C 7/04; B05C 9/14; B05C 9/10; F26B 21/006; B01J 35/04; B01J 37/0244; B01J 37/08

(57) ABSTRACT

The principles and embodiments of the present invention relate generally to an apparatus, system, and methods for coating and calcining a catalytic substrate inline, reducing the processing time to prepare a substrate coated with catalytic material. For example, the disclosure describes a multi-station coater system comprising: a raw weight station, wherein an initial weight of a substrate is measured; a first catalytic substrate coating station, wherein a first wet coating comprising a first catalytic coating and a first carrier liquid is introduced into longitudinal cells of the substrate; a first wet weight station, wherein a wet weight of the substrate is measured; a first inline calciner module, wherein a heating fluid is introduced into the substrate to calcine the catalytic coating; and a first calcined weight station, wherein a calcined weight of the substrate is measured.

### TECHNICAL FIELD OF THE INVENTION

Principles and embodiments of the present invention relate generally to systems and methods of applying a coating to a substrate as part of a continuous catalytic coating operation.

### BACKGROUND OF THE INVENTION

Catalytic converters are well known for the removal and/or conversion of the harmful components of exhaust gases. While catalytic converters have a variety of constructions for this purpose, one form of construction is a catalytically coated rigid skeletal monolithic substrate or honeycomb-type element which has a multiplicity of longitudinal channels or cells to provide a catalytically coated body having a high surface area. The rigid, monolithic substrate is fabricated from ceramics and other materials. Such materials and their construction are described, for example, in US. Pat. Nos. 3,331,787 and 3,565,830 each of which is incorporated herein by reference.

A monolithic honeycomb substrate will typically have an inlet end and an outlet end, with multiple mutually adjacent cells extending along the length of the substrate body from the inlet end to the outlet end. These honeycomb substrates typically have from about 100 to 600 cells-per-square-inch (cpsi), but may have a densities range from 10 cpsi to 1200 cpsi. Cells having round, square, triangular, or hexagonal cell shapes are known in the art.

The open frontal area may comprise 50% to 85% of the surface area, and the cell wall thickness may be from 0.5 to 10 mils, where 1 mil is 0.001 inches. The cells also may be separated from one another by walls with a thickness in the range of about 0.5 mils to about 60 mils (0.012 mm to 1.5 mm). In some cases the open frontal area may be as much as 91% for a 600 cpsi substrate with 2 mil cell wall thickness. The cell walls of the substrate may be porous or non-porous, smooth or rough. For porous walls, an average wall pore diameter may be from about 0.1 to about 100 microns, and wall porosity may typically range between about 10-85%.

Such monolithic catalytic substrates may have one, two, or more catalytic coatings deposited on the cell walls of the substrate. The catalytic material may be carried as a dissolved compound in a solution or as a suspended solid in a slurry. The carrier and coating is introduced into the cells and deposits on the walls in a wet state that may then be dried and calcined. This coating process has involved using a vacuum to suck up the solution or slurry an intended distance into the cells, where an intended amount of catalytic material may then adhere to the walls when the carrier liquid is removed. The coating operation may not deposit the same amount of catalytic material onto the walls of different cells, or may not suck the solution or slurry a uniform distance into each of the cells. In addition, coated catalytic substrates have been calcined offline in an oven, where substrates typically pass horizontally through the oven as hot gas is passed through and around the substrate. Online calcining and drying at high temperatures were avoided due to fear of thermal shock to the substrates resulting from the need for higher temperatures for calcining compared to drying and the temperature gradients created by the rapid heating required to maintain the same inline coating and transfer rates, and without slowing the production line down. It would be desirable to develop new methods and processes for coating operations to decrease the time required for coating a monolithic catalytic substrates while increasing the homogeneity of the depth and loading. Furthermore, it would be desirable to include on-line processes for calcining of the catalytic material to improve manufacturing efficiency.

### SUMMARY OF THE INVENTION

Various embodiments are listed below. It will be understood that the embodiments listed below may be combined not only as listed below, but in other suitable combinations in accordance with the scope of the invention.

An aspect of the present invention relates to a multi-station coater system comprising a raw weight station, wherein an initial weight of a substrate is measured, a first catalytic substrate coating station, wherein a first wet coating comprising a first catalytic coating and a first carrier liquid is introduced into longitudinal cells of the substrate, a first wet weight station, wherein a first wet weight of the substrate is measured, a first inline calciner module, wherein a heating fluid is introduced into the substrate to calcine the first catalytic coating at a first calcining temperature, and a first calcined weight station, wherein a calcined weight of the substrate is measured.

In some embodiments, the multi-station coater system further comprises a first multi-phase drying station subsequent to the first wet weight station and preceding the first inline calciner module, wherein the first carrier liquid of the first wet coating is at least partially evaporated from the longitudinal cells of the substrate to produce an at least substantially dried substrate having a temperature and a first cooling station and a first dry weight station subsequent to the first multi-phase drying station, wherein, at the cooling station, the temperature of the substantially dried substrate decreases, and, at the dry weight station, a first dry weight of the substrate containing the deposited first catalytic coating is measured.

In some embodiments, the multi-station coater system further comprises a second catalytic substrate coating station, wherein a second wet coating comprising a second catalytic coating and a second carrier liquid is introduced into the longitudinal cells of the substrate, a second wet weight station, wherein a second wet weight of the substrate is measured after the second wet coating is introduced into the longitudinal cells of the substrate, and a second multi-phase drying station, wherein the second carrier liquid of the second wet coating is at least partially evaporated from the longitudinal cells of the substrate to produce an at least substantially dried substrate.

In some embodiments, the first wet coating coats a portion of the longitudinal cells of the substrate, the substrate is flipped before the second wet coating is introduced into the longitudinal cells of the substrate, and the second wet coating coats at least a portion of the longitudinal cells of the substrate not coated by the first wet coating.

In some embodiments, the multi-station coater system further comprises a second cooling station subsequent to the first inline calciner module, wherein the temperature of the substrate decreases to an intermediate temperature between the calcining temperature and room temperature and a third cooling station, wherein the temperature of the substrate further decreases from an intermediate temperature to room temperature.

In some embodiments, the multi-station coater system further comprises a third catalytic substrate coating station subsequent to the third cooling station, wherein a third wet coating comprising a third catalytic coating and a third carrier liquid is introduced into the longitudinal cells of the substrate, a third wet weight station, wherein a third wet weight of the substrate is measured and a third multi-phase drying station subsequent to the third wet weight station, wherein at least a portion of the third carrier liquid of the third wet coating is evaporated from the longitudinal cells of the substrate to produce an at least partially dried substrate.

In some embodiments, the multi-station coater system further comprises a fourth catalytic substrate coating station, wherein a fourth wet coating comprising a fourth catalytic coating and a fourth carrier liquid is introduced into the substrate, a fourth wet weight station, wherein a fourth wet weight of the substrate is measured and a fourth multi-phase drying station subsequent to the fourth wet weight station and preceding the first calciner module, wherein at least a portion of the fourth carrier liquid of the fourth wet coating is evaporated from the longitudinal cells of the substrate to produce an at least partially dried substrate.

In some embodiments, the third wet coating coats a portion of the longitudinal cells of the substrate, the substrate is flipped before the fourth wet coating is introduced into the longitudinal cells of the substrate, and the fourth wet coating coats at least a portion of the longitudinal cells of the substrate not coated by the third wet coating.

In some embodiments, the multi-station coater system further comprises a controller in electrical communication with at least the first wet weight station and the first dry weight station, wherein the initial weight of the substrate is compared to the first wet weight of the substrate, and the substrate is not inserted into the first inline calciner module if the difference between the initial weight of the substrate and the wet weight of a substrate is outside of an intended value to avoid calcining an out-of-specification substrate.

In some embodiments, the multi-station coater system further comprises a loading station, wherein a substrate comprising a plurality of cells is loaded into at least one catalytic substrate coating station and a transfer mechanism that moves a substrate sequentially from a preceding modular station to subsequent modular station, wherein a substrate introduced at a loading station is transferred from a preceding modular station to a subsequent modular station in the range of about every 7 to about 10 seconds.

Another aspect of the invention is directed to a multi-station coater system comprising a raw weight station, wherein an initial weight of a substrate is measured, a first bottom coat station, wherein a first wet coating comprising a first catalytic coating and a first carrier liquid is introduced into longitudinal cells of the substrate, a first wet weight station, wherein a first wet weight of the substrate is measured, a first finesse drying station, wherein the carrier liquid of the first wet coating is at least partially evaporated from the longitudinal cells of the substrate to produce an at least partially dried substrate, a second bottom coat station, wherein a second wet coating comprising a second catalytic coating and a second carrier liquid is introduced into the longitudinal cells of the at least partially dried substrate, a second finesse drying station, wherein the second carrier liquid of the second wet coating is at least partially evaporated from the cells of the substrate to produce an at least partially dried substrate, a first inline calciner module, wherein a heating fluid is introduced into the substrate to calcine the first and second catalytic coatings and a first calcined weight station, wherein a calcined weight of the substrate is measured.

In some embodiments, the multi-station coater system further comprises a first intermediate drying station subsequent to at least one finesse drying station preceding the first inline calciner module, wherein at least a portion of at least one carrier liquid of at least one wet coating is evaporated from the longitudinal cells of the substrate to produce an at least partially dried substrate, a second intermediate drying station subsequent to at least one finesse drying station preceding the first inline calciner module, wherein at least a portion of remaining carrier liquid of at least one wet coating is evaporated from the longitudinal cells of the substrate to produce a substantially dry substrate, a third intermediate drying station subsequent to at least one finesse drying station preceding the first inline calciner module, wherein at least a portion of remaining carrier liquid of at least one wet coating is evaporated from the longitudinal cells of the substrate to produce a dry substrate, a first final drying station subsequent to the first finesse drying station and preceding the second bottom coat station, wherein remaining carrier liquid of the first wet coating is evaporated from the longitudinal cells of the substrate to produce a dry substrate and a second final drying station subsequent to the second finesse drying station and preceding the first inline calciner module, wherein carrier liquid of the second wet coating is evaporated from the longitudinal cells of the substrate to produce a dry substrate.

In some embodiments, the multi-station coater system further comprises a third catalytic substrate coating station, wherein a third wet coating comprising a third catalytic coating and a third carrier liquid is introduced into the longitudinal cells of the substrate, a second wet weight station, wherein a wet weight of the substrate is measured, a third finesse drying station, wherein the carrier liquid of the third wet coating is at least partially evaporated from the longitudinal cells of the substrate to produce an at least partially dried substrate, a fourth catalytic substrate coating station, wherein a fourth wet coating comprising a fourth catalytic coating and a fourth carrier liquid is introduced into the longitudinal cells of the at least partially dried substrate, a fourth finesse drying station, wherein the fourth carrier liquid of the fourth wet coating is at least partially evaporated from the longitudinal cells of the substrate to produce an at least partially dried substrate and a second inline calciner module, wherein a heating fluid is introduced into the substrate to calcine the third and fourth catalytic coatings.

In some embodiments, the multi-station coater system further comprises a third intermediate drying station, wherein at least a portion of carrier liquid of any wet coating is evaporated from the longitudinal cells of the substrate to produce an at least partially dried substrate, a fourth intermediate drying station, wherein at least a portion of remaining carrier liquid of any wet coating is evaporated from the longitudinal cells of the substrate to produce a substantially dry substrate, a third final drying station, wherein remaining carrier liquid of any wet coating is evaporated from the longitudinal cells of the substrate to produce a dry substrate, a fourth final drying station, wherein carrier liquid of any wet coating is evaporated from the cells of the substrate to produce a dry substrate, a third inline calciner module, wherein a heating fluid is introduced into the dried substrate to calcine the deposited catalytic coating at a calcining temperature to produce a calcined substrate having a temperature, a first cooling station, wherein the temperature of the calcined substrate decreases to an intermediate temperature between the calcining temperature and room temperature and a second cooling station, wherein the intermediate temperature of the calcined substrate further decreases to room temperature.

Another aspect of the invention is directed to a modular, multi-station coater system comprising a modular raw weight station, wherein an initial weight of a substrate is measured, at least one modular coating station, wherein a wet coating is introduced into a plurality of cells of the substrate, at least one wet-weight station, wherein a weight of the substrate having an introduced wet coating is measured and at least one modular inline calciner station, wherein the wet coating introduced into the plurality of cells of the substrate is calcined.

In some embodiments, the modular inline calciner station introduces a heating fluid at a temperature in the range of about 350° C. to about 550° C. into the substrate for a time in the range of about 7 seconds to about 15 seconds to calcine the wet coating.

In some embodiments, the modular, multi-station, coater system further comprises at least one drying station subsequent to the at least one wet-weight station and preceding the at least one modular inline calciner station, wherein the substrate has a temperature and the at least one drying station increases the temperature of the substrate to a temperature of no more than about 210° C. while evaporating a liquid carrier of the wet coating.

In some embodiments, the modular, multi-station, coater system further comprises at least one modular calcined weight station, wherein a calcined weight of the substrate is measured and a transfer mechanism that conveys a substrate sequentially between the modular stations, wherein the modular, multi-station, coater system applies about 350 to about 450 coats per hour and calcines about 350 to about 450 substrates per hour.

In some embodiments, the modular, multi-station coater system produces one calcined substrate having two bottom coats and two top coats about every 8 to about 10 seconds when each station of the modular, multi-station coater system is occupied by a substrate.

Another aspect of the invention is directed to an apparatus for applying a metered coating to a substrate, which comprises a substrate receiving portion comprising a pressure compartment and a containment compartment, wherein the pressure compartment and the containment compartment are configured and dimensioned to fit over a substrate and form a fluid-tight seal with the substrate when in a closed position, a pressurized gas source, which provides a gas at an adjustable pressure, operatively associated and in fluid communication with the pressure compartment, wherein pressurized gas is delivered to the pressure compartment, a pressure controller operatively associated with the pressurized gas source that adjusts the pressure of the gas delivered to the pressure compartment and a catalytic coating source, which provides a wet coating, operatively associated and in fluid communication with the containment compartment, wherein the wet coating is delivered to the containment compartment.

In some embodiments, the apparatus further comprises a pressure sensor operatively associated with the pressure compartment and the pressurized gas source that measures gas pressure in the pressure compartment and provides a feedback signal to the pressure controller.

In some embodiments, the pressurized gas source is a compressor, a gas cylinder, or in-house gas line, and the pressure controller is an electronic pressure control valve operatively associated and in fluid communication with the pressurized gas source and pressure compartment.

In some embodiments, the substrate having a plurality of cells and the pressurized gas source provides the gas at a pressure sufficient to support the weight of a column of a slurry having a pre-determined height above each of the plurality of cells.

In some embodiments, the catalytic coating source comprises a catalytic coating reservoir for providing a quantity of wet coating for injection into the containment compartment, a wet coating pump operatively associated and in fluid communication with the coating reservoir, and an injection nozzle operatively associated and in fluid communication with the containment compartment.

In some embodiments, the apparatus further comprises a fluid level transducer operatively associated with the containment compartment, wherein the fluid level transducer detects a coating fluid level of the wet coating within the containment compartment. Principles and embodiments relate to providing an inline metered coating apparatus that reduces variations in penetration depth of the coating, decreases the amount of out-of-spec substrates, and increases the resulting through-put of the catalytic substrates by a catalytic coating machine.

Principles and embodiments also relate to an apparatus and process for calcining a monolithic catalytic substrate as part of a complete catalytic coating process involving a liquid coating with a solution and/or slurry containing precious and/or base metals and drying of the wet catalytic substrate. Principles and embodiments also relate to an apparatus for coating a monolithic catalytic substrate comprising a substrate-receiving portion comprising a pressure compartment and a containment compartment, wherein the pressure compartment and the containment compartment, are configured and dimensioned to fit over a catalytic substrate and form a fluid-tight seal with the substrate when in a closed position, and a catalytic coating source, which provides an intended volume of the catalytic coating, operatively associated and in fluid communication with the containment compartment, wherein the catalytic coating is delivered to an inlet of the containment compartment.

In various embodiments, the apparatus further comprises a catalytic coating pump operatively associated and in fluid communication with the catalytic coating source to propel the catalytic coating to the containment compartment.

In various embodiments, the apparatus further comprises a pressurized gas source, which provides a gas at an adjustable pressure, operatively associated and in fluid communication with the pressure compartment, wherein the pressurized gas is delivered to the pressure compartment

In various embodiments, the pressurized gas source is a blower or compressor that produces a pressurized gas at a pressure sufficient to support the weight of the catalytic coating above a catalytic substrate.

In various embodiments, the apparatus further comprises a transfer mechanism operatively associated with the coating apparatus and a preceding module, wherein the transfer mechanism provides a transfer path between the preceding module and the coating apparatus. Principles and embodiments of the present invention also relate to a system for preparing a catalytic substrate, comprising a first catalytic substrate coating station that applies at least one washcoat comprising a catalytic slurry and a liquid carrier to at least a portion of the catalytic substrate, at least one drying station that removes at least a portion of the liquid carrier from the at least a portion of the catalytic substrate; and one or more calcining stations comprising an upper calciner section and a lower calciner section, wherein the upper calciner section and the lower calciner section are configured and dimensioned to fit over the catalytic substrate and form a fluid-tight seal, and a heating fluid source that supplies a volume of heating fluid at an intended temperature operatively associated with the lower calciner section, wherein the heating fluid is delivered to an inlet end of the lower calciner section to calcine the catalytic slurry of the washcoat to the cell walls of the catalytic substrate, and a substrate gripper that holds the catalytic substrate and transfers the catalytic substrate between the catalytic substrate coating station, the at least one drying station, and the one or more calcining stations, wherein one calcining station of the one or more calcining stations is adjacent to one of the at least one drying stations. In one or more embodiments, a calcining station may be adjacent to a final drying station or a multi-stage drying station.

In various embodiments, the substrate gripper comprises a silicone rubber insert that can operate continuously at 600° F.

In various embodiments, the system further comprises a second catalytic substrate coating station that applies at least one additional washcoat comprising a catalytic slurry and a liquid carrier to at least a portion of the catalytic substrate after the catalytic substrate has been calcine at least once at the one or more calcining station, and at least one weighing station that measures the weight of the catalytic substrate, wherein the substrate gripper transfers the catalytic substrate from the catalytic substrate coating station, the drying station, or the calcining station to the at least one weighing station to determine a wet and/or a dry weight of the catalytic substrate.

Principles and embodiments of the present invention also relate to a method of preparing a catalytic substrate, comprising positioning a catalytic substrate comprising a plurality of longitudinal cells between a pressure compartment and a containment compartment, moving the pressure compartment and/or containment compartment linearly to encase the catalytic substrate within the containment compartment and pressure compartment, wherein a fluid-tight seal is formed by the containment compartment and the pressure compartment around the catalytic substrate such that a pressure fluid delivered to the pressure compartment enters the plurality of longitudinal cells of the catalytic substrate at an intended pressure to support an amount of wet coating in the containment compartment above the catalytic substrate.

In various embodiments, the pressure fluid is delivered to the inlet end of the pressure compartment at a pressure sufficient to support the weight of a column of a slurry having a pre-determined height above each of the plurality of cells, where the predetermined height relates to the length of coating applied to each cell of the substrate. In various embodiments, the method further comprises reducing the pressure of the pressure fluid supplied to the pressure compartment to allow the wet coating to flow into the cells of the substrate under the force of gravity and/or vacuum to deliver the catalytic coating to the cell walls.

In various embodiments, the method further comprises conveying the catalytic substrate from the coating apparatus to an inline drying module to evaporate at least a portion of the carrier liquid of the wet coating.

In various embodiments, the inline drying module raises the catalytic substrate to an intended temperature in the range of about 50° C. to about 200° C.

In various embodiments, the method further comprises conveying the catalytic substrate from the inline drying module to an inline calcining module to calcine the catalytic coating on the walls of the catalytic substrate.

### BRIEF DESCRIPTION OF THE DRAWINGS

Further features of embodiments of the present invention, their nature and various advantages will become more apparent upon consideration of the following detailed description, taken in conjunction with the accompanying drawings, which are also illustrative of the best mode contemplated by the applicants, and in which like reference characters refer to like parts throughout, where:

FIG. 1 illustrates an exemplary embodiment of an inline calcining apparatus depicting a substrate-receiving portion in an open position;

FIG. 2 illustrates an exemplary embodiment of an apparatus for applying a metered coating to a substrate in an open position;

FIG. 3 illustrates an exemplary embodiment of an apparatus for applying a metered coating to a substrate in a closed position;

FIG. 4 illustrates another exemplary embodiment of an inline coating apparatus depicting a substrate-receiving portion in a closed position;

FIG. 5A illustrates a cross-section of an exemplary embodiment of a circular substrate-receiving portion;

FIG. 5B illustrates a cross-section of an exemplary embodiment of a rectangular substrate-receiving portion;

FIG. 6A illustrates a wet coating process utilizing an exemplary inline coater module, wherein the containment compartment housing and pressure compartment housing encase a catalytic substrate;

FIG. 6B illustrates a wet coating process utilizing an exemplary inline coater module, wherein the continued influx of wet coating is counterbalanced with gas pressure;

FIG. 6C illustrates a wet coating process utilizing an exemplary inline coater module, wherein the flow of wet coating penetrates an intended distance into the cells of the catalytic substrate;

FIG. 7A illustrates a top view of an exemplary embodiment of a gripper assembly;

FIG. 7B illustrates a front cut-away view of an exemplary embodiment of a gripper assembly;

FIG. 8 illustrates an exemplary embodiment of a method of coating a catalytic substrate;

FIG. 9 illustrates an exemplary embodiment of a multi-station coater system; and

FIG. 10 illustrates another exemplary embodiment of a multi-station coater system.

### DETAILED DESCRIPTION OF THE INVENTION

Before describing several exemplary embodiments of the invention, it is to be understood that the invention is not limited to the details of construction or process steps set forth in the following description. The invention is capable of other embodiments and of being practiced or being carried out in various ways.

As used herein, the term “partially dry” or “partially dried” is intended to mean that about 70% of the volatile fraction weight of the carrier liquid absorbed onto the substrate is removed by drying.

As used herein, the term “substantially dry” or “substantially dried” is intended to mean that about 70% to about 90% of the volatile fraction weight of the carrier liquid absorbed onto the substrate has been removed. The term “at least substantially dry” or “at least substantially dried” is intended to include “substantially dry/dried,” as well as further dried, e.g., completely dry/dried. As such, “at least substantially dry” or “at least substantially dried” means that about 70% to about 100% of the volatile fraction weight of the carrier liquid absorbed onto the substrate has been removed.

As used herein, the term “essentially dry” or “ essentially dried” is intended to mean that while there may be some carrier liquid or solvent trapped within inclusions or strongly absorbed (e.g., mono-layer hydrogen-bonded or chemically adsorbed water and/or volatile organics) on the surfaces of a deposited material, more than 90% of the weakly absorbed liquid (e.g., multi-layer physically adsorbed water) has been removed. In various embodiments, more than 95%, or more than 99% of the weakly absorbed liquid (e.g., multi-layer physically adsorbed water and/or volatile organics) has been removed before introducing a coated substrate into an inline calciner and calcining the essentially dried coating.

Principles and embodiments relate to an apparatus that applies a wet coating, also referred to as a washcoat, to the cell walls of a monolithic catalytic substrate coated to produce a substrate with a catalytic material coating, where the apparatus may be in line with other catalytic substrate manufacturing stations.

In one or more embodiments, a coating apparatus utilizes a fluid under pressure to hold a slurry above a catalytic substrate, as the amount of slurry is increased to an intended volume, and then the pressure of the fluid is slowly reduced to allow the slurry to flow into the cells of the substrate under gravity and capillary forces, so a slurry plug is pulled uniformly into the substrate cells. In various embodiments, the pressure may be reduced below atmospheric pressure, so the wet coating flows into the cells of the substrate under gravity, capillary forces, and vacuum. In various embodiments, the viscosity and/or surface energy of the wet coating may be adjusted, so that gravity and the capillary forces of the substrate cells are balanced, and the wet coating will only flow into the substrate cells when a vacuum is applied.

In one or more embodiments, a washcoat, also referred to as a wet coating, may be formed by preparing a slurry containing a specified solids content (e.g., 10-60% by weight) of catalyst in a liquid carrier or vehicle, which is then coated onto a substrate and dried to provide a washcoat layer. As used herein, the term “washcoat” has its usual meaning in the art of a thin, adherent coating of a catalytic or other material applied to a substrate material, such as a honeycomb-type carrier member, which is sufficiently porous to permit the passage of a gas stream being treated.

In various embodiments, the washcoat or wet coating comprises a base metal catalyst selected from the group consisting of calcium, barium, strontium, cerium, cesium, copper, iron, nickel, cobalt, manganese, chromium, vanadium, and combinations thereof, which may be a soluble compound dissolved in a liquid carrier (e.g., H₂O).

In various embodiments, the slurry may comprise alumina, molecular sieves, silica-alumina, zeolites, zirconia, titania, lanthana, and combinations thereof.

In various embodiments, the slurry may comprise oxides of calcium, barium, strontium, cerium, cesium, copper, iron, nickel, cobalt, manganese, chromium, vanadium, and combinations thereof.

In various embodiments, the concentration of the coating solution for preparing a washcoat may be between about 0.5% and about 5% by weight of platinum group metal (PGM), or alternatively, the coating solution may have a concentration of between about 1% and about 2% by weight of platinum group metal, or about 1.5% by weight of platinum group metal.

In various embodiments, the coating solution comprises platinum, which may be a soluble compound dissolved in a liquid carrier. The soluble platinum compound may be for example, chloroplatinic acid, platinum (IV) chloride, K₂PtCl₄, and platinic sulfates.

In various embodiments, the catalytic substrate comprises a monolithic ceramic or metal honeycomb structure, where the monolithic substrate can have fine, parallel gas flow passages extending longitudinally such that the passages are open to fluid flow there through. The passages, which are essentially straight paths from their fluid inlet to their fluid outlet, are defined by walls on which the catalytic material is coated as a washcoat so that the gases flowing through the passages contact the catalytic material. The flow passages of the monolithic substrate can be thin-walled channels, which can be of any suitable cross-sectional shape and size such as trapezoidal, rectangular, square, sinusoidal, hexagonal, oval, circular, etc.

Such structures may contain from about 60 to about 900 or more gas inlet openings (i.e., cells) per square inch of cross section.

In one or more embodiments, the catalytic substrate may have a circular cross-section, a rectangular cross-section, or a square cross-section, with a width, diagonal distance, or diameter in the range of about 2 inches to about 14 inches, and a length (height) in the range of about 2 inches to about 12 inches. In various embodiments, the catalytic substrate may have a width, diagonal distance, or diameter in the range of about 3 inches to about 7 inches, and a length (height) in the range of about 4 inches to about 8 inches. In various embodiments, the height and largest perpendicular dimension (width, length, and diameter) does not exceed 7 inches.

Principles and embodiments relate to a system that calcines a monolithic catalytic substrate coated with a catalytic material in line with other catalytic manufacturing stations. A related apparatus is disclosed in International PCT Patent Application No. PCT/US2016/22893 to Gary Gramiccioni et al., which is incorporated herein by reference in its entirety for all purposes.

Calcining relates to a decomposition and/or phase change of a washcoat layer deposited on the walls of a substrate compared to drying of a washcoat, which relates to removing at least some amount of a liquid carrier for example by evaporation.

An aspect of the invention relates to an apparatus that is configured and dimensioned to receive a monolithic catalytic substrate, force hot air into an end of the catalytic substrate to remove liquid material, and calcine material deposited on the surface(s) of the interior cell walls of the catalytic substrate.

Another aspect of the present invention relates to a method of calcining a monolithic catalytic substrate having a washcoat layer by forcing hot air into an end of the monolithic catalytic substrate to remove liquid material while affixing the slurry and catalytic material onto the surface of the interior walls of the catalytic substrate. In various embodiments, the catalytic material may be a platinum group metal (PGM) including, platinum, palladium, rhodium, ruthenium, osmium, and iridium, or combinations thereof, base metals, or metal oxides.

Another aspect of the present invention relates to a multi-station catalytic substrate processing system comprising one or more coating apparatus, one or more calcining apparatus, one or more weighing apparatus, one or more drying apparatus, one or more transfer apparatus, and/or a loading apparatus, where the coating apparatus applies a wet catalytic coating to a substrate and the calcining apparatus receives a catalytic substrate with a catalytic coating from a preceding station in the multi-station catalytic substrate processing system and calcines the catalytic coating.

Another aspect of the present invention relates generally to a method of manufacturing a plurality of catalytic substrates by transferring each of the plurality of catalytic substrates from a preceding station to a subsequent station in a sequential manner, where each station performs a production operation including at least coating, drying, and calcining on the catalytic substrates.

Principles and embodiments of the present invention also relate to increasing the rate a catalytic substrate is prepared by eliminating off-line calcining of the catalytic material adsorbed onto the cell walls of the catalytic substrate.

Embodiments of the calcining apparatus generate hot air or gas and introduce the hot air or gas into a catalytic substrate to evaporate the liquid component of a washcoat comprising a catalytic precursor and/or slurry material and a liquid carrier, and then bringing the impregnated catalytic substrate up to a temperature sufficient to bake the catalytic precursor and/or catalytic slurry onto the cell walls of the catalytic substrate.

Embodiments of the present invention relate to a calcining apparatus that can heat a catalytic substrate to a calcining temperature in a single processing time period.

Embodiments of the present invention relate to an apparatus that can supply a heating fluid to a catalytic substrate in a reduced amount of time sufficient to raise at least the internal temperature of the catalytic substrate to a value at which the washcoat will calcine, while reducing or avoiding the amount of thermal shock produced in the substrate. It has been found that offline calcining created radial temperature gradients from the outside surface inward due to the portion of hot gas passing around the outside of the catalytic substrate, whereas the inline calciner principally forces the hot gas through the cells and heating them more uniformly, and thereby avoids such radial temperature gradients.

Principles and embodiments of the present invention relate to a system for affixing a catalytic coating on the inside walls of a monolithic catalytic substrate comprising evaporating the liquid carrier from the catalytic substrate at a temperature in the range of about 100° C. to about 115° C. (about 212° F. to about 239° F.) for a time in the range of 5 seconds to about 30 seconds, drying the catalytic substrate at a temperature in the range of about 170° C. to about 235° C. (about 338° F. to about 455° F.) for a time in the range of 5 seconds to about 30 seconds, and calcining the catalytic substrate at a temperature in the range of about 350° C. to about 425° C. (about 662° F. to about 797° F.) for a time in the range of 5 seconds to about 30 seconds, or about 375° C. to about 550° C. (about 707° F. to about 1022° F.) for a time in the range of 5 seconds to about 30 seconds. In various embodiments, the calcining of the catalytic substrate may be accomplished by a calcining station, also referred to as an inline calciner, as described herein.

In various embodiments, the drying temperature is sufficient to raise the substrate temperature to a value at which a sufficient amount of carrier fluid evaporates before the wet coating media may flow further downward along the walls of the substrate cells under the force of gravity.

In one or more embodiments, the catalytic substrate may be calcined at a temperature in the range of about 350° C. to about 550° C. (about 662° F. to about 1022° F.) for a time in the range of 7 seconds to about 15 seconds, or about 375° C. to about 540° C. (about 707° F. to about 1004° F.) for a time in the range of 7 seconds to about 15 seconds.

In one or more embodiments, the liquid carrier may be removed from a catalytic substrate by evaporating the liquid carrier at a temperature in the range of about 105° C. to about 110° C. (about 212° F. to about 230° F.) for a time in the range of 15 seconds to about 23 seconds, drying the catalytic substrate at a temperature in the range of about 200° C. to about 207° C. (about 392° F. to about 405° F.) for a time in the range of 15 seconds to about 23 seconds, and calcining the catalytic substrate at a temperature in the range of about 395° C. to about 405° C. (about 743° F. to about 761° F.) for a time in the range of 7 seconds to about 14 seconds. In various embodiments, the catalytic substrate is dried prior to calcining.

In one or more embodiments, the catalytic substrate may be calcined at a temperature in the range of about 465° C. to about 470° C. (about 869° F. to about 878° F.) for a time in the range of 8 seconds to about 12 seconds.

In one or more embodiments, the catalytic substrate may be calcined at a temperature in the range of about 535° C. to about 540° C. (about 995° F. to about 1004° F.) for a time in the range of 8 seconds to about 12 seconds.

In some embodiments, the catalytic substrate may be calcined at least once, or at least twice, or at least three times. In some embodiments, the catalytic substrate may be calcined at least twice, wherein the first calcining temperature and subsequent calcining temperatures (e.g., second calcining temperature) may be the same or different temperature. For example, the catalytic substrate may be calcined at least twice at the same calcining temperature. In another example, the catalytic substrate may be calcined at a first calcining temperature and a second calcining temperature, wherein the first calcining temperature is different than the second calcining temperature.

In various embodiments, the drying fluid and/or heating fluid may be air, a combination of air and combustion gases (e.g., CO, CO₂, NOx, H₂O), or a single gas, such as dry nitrogen. Principles and embodiments of the present invention relate to a system for removing a liquid carrier from a catalytic coating on the inside walls of a monolithic catalytic substrate comprising passing a drying fluid through the cells of the catalytic substrate at a volumetric flow rate of about 200 acfm to about 400 acfm at a temperature in the range of about 100° C. to about 115° C. (about 212° F. to about 239° F.) for a time in the range of 5 seconds to about 30 seconds, drying the catalytic substrate at a temperature in the range of about 170° C. to about 235° C. (about 338° F. to about 455° F.) for a time in the range of 5 seconds to about 30 seconds, and calcining the catalytic substrate at a temperature in the range of about 350° C. to about 425° C. (about 662° F. to about 797° F.) for a time in the range of 5 seconds to about 30 seconds, or in the range of about 375° C. to about 540° C. (about 707° F. to about 1004° F.) for a time in the range of 5 seconds to about 30 seconds.

In various embodiments, the calcination temperature is at least 575° F./301° C.

In various embodiments, the catalytic substrate temperature increases from room temperature to about 210° C. to evaporate the liquid carrier, and from about 301° C. to about 540° C. to calcine the slurry solids.

The ceramic substrate may be made of any suitable refractory material, e.g. cordierite, cordierite-α-alumina, silicon nitride, silicon carbide, zircon mullite, spodumene, alumina-silica-magnesia, zircon silicate, sillimanite, a magnesium silicate, zircon, petalite, α-alumina, an aluminosilicate and the like, where such materials are able to withstand the environment, particularly high temperatures, encountered in treating the exhaust streams.

In one or more embodiments, catalytic substrates include thin porous walled honeycomb monoliths through which the fluid stream passes without causing too great an increase in back pressure or pressure across the article.

Principles and embodiments of the present invention relate to a calcining system that holds a catalytic substrate within an enclosed chamber, and utilizes a heating fluid to heat the interior of a catalytic substrate up to a calcining temperature.

In various embodiments, a catalytic substrate may be received by a substrate-receiving portion of the calciner, and a short blast of hot gases passed through the substrate cells to raise the temperature of the substrate and calcine any catalytic materials previously deposited on the cell walls. In various embodiments, the temperature of the catalytic substrate may be raised to a temperature at which exothermic reactions between the hot gases and the catalytic coating(s) occur to cause de-greening of the catalytic substrate.

In one or more embodiments, the catalytic substrate is heated from the inside out by passing hot gas(es) through the cells of the substrate without the hot gas(es) passing around the outside surface of the substrate. In various embodiments, a radial temperature gradient created by heating the catalytic substrate from the outside in apparently contributes to longitudinal and radial stresses, which become most evident upon cool down. Thermally induced stress and thermal shock can create cracks and other structural damage to the substrate. In various embodiments, a radial temperature gradient, induced stress, and thermal shock is reduced or avoided by heating the substrate from the inside out by passing hot gas(es) through the cells of the substrate with the inline calcining system described herein.

Various exemplary embodiments of the invention are described in more detail with reference to the figures. It should be understood that these drawings only illustrate some of the embodiments, and do not represent the full scope of the present invention for which reference should be made to the accompanying claims.

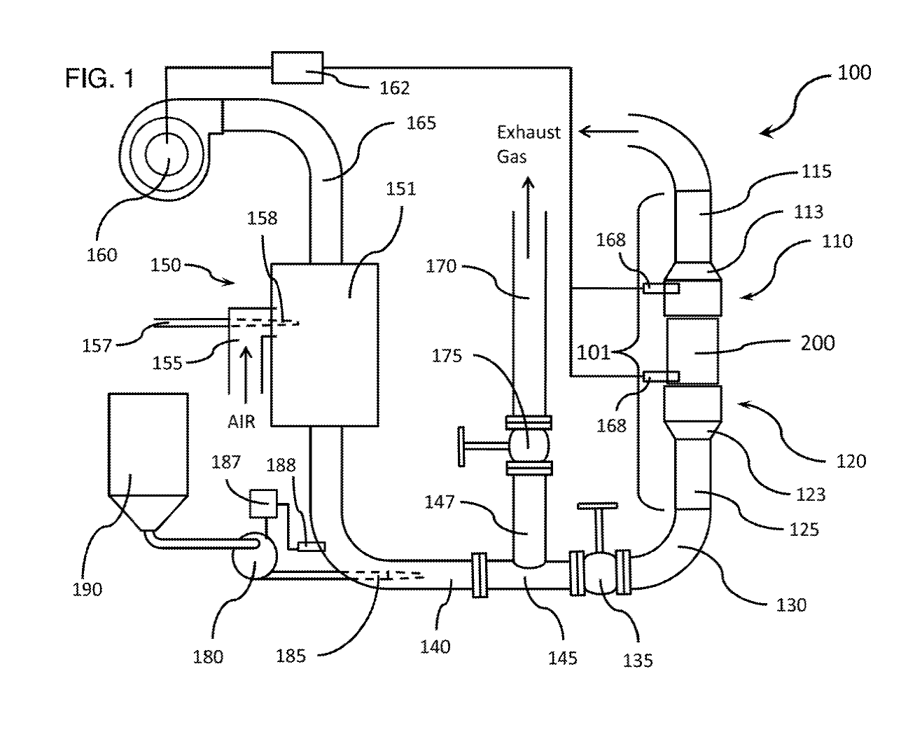

FIG. 1 illustrates an exemplary embodiment of a calcining system 100 in an open position. In one or more embodiments, an inline calciner 100 may comprise a substrate-receiving portion 101 comprising an upper calciner section 110 that is configured and dimensioned to fit over at least a portion of a catalytic substrate 200, and a lower calciner section 120 that is configured and dimensioned to fit over at least a portion of a catalytic substrate 200 to form an enclosed chamber.

In various embodiments, the lower calciner section 120 fits over approximately a lower half of the catalytic substrate 200, and the upper calciner section fits over approximately an upper half of the catalytic substrate, when the catalytic substrate 200 is positioned vertically and horizontally so the longitudinal axis of the catalytic substrate is aligned with the longitudinal axis of the upper and lower calciner sections.

In one or more embodiments, the upper calciner section 110 and lower calciner section 120 are coaxial, and may move longitudinally relative to each other. In various embodiments, the longitudinal motion of the upper calciner section 110 may be controlled by a linear actuator (not shown). In various embodiments, the longitudinal motion of the lower calciner section 120 may be controlled by a linear actuator (not shown). In various embodiments, the upper calciner section 110 and/or lower calciner section 120 move linearly between an open position and a closed position.

In various embodiments, the hollow interior portions of the upper and lower calciner sections are configured and dimension to match the size and shape of the catalytic substrate intended to be held inside.

In one or more embodiments, the upper calciner section 110 comprises an inlet end and an outlet end, where the outlet end may be connected to and in fluid communication with an upper connecting duct 115, wherein the upper connecting duct may allow axial extension of the upper calciner section 110, while maintaining a fluid-tight path to the outlet end of the upper calciner section 110. In various embodiments, the inlet end of the upper calciner section 110 may be configured and dimensioned to fit over a catalytic substrate and form a fluid-tight seal when in a closed position. In various embodiments, the upper connecting duct 115 may be a bellows or an arrangement of concentric telescoping sleeves and/or ducts. In various embodiments, the inlet end fits over an intended catalytic substrate.

In one or more embodiments, the lower calciner section 120 comprises an inlet end and an outlet end, where the inlet end may be connected to and in fluid communication with a lower connecting duct 125, wherein the lower connecting duct may allow axial extension of the lower calciner section 120, while maintaining a fluid-tight path to the inlet end of the lower calciner section 120. In various embodiments, the outlet end of the lower calciner section 120 may be configured and dimensioned to fit over a catalytic substrate and form a fluid-tight seal when in a closed position. In various embodiments, the lower connecting duct 125 may be a bellows or an arrangement of concentric telescoping sleeves or ducts. In various embodiments, the outlet end fits over an intended catalytic substrate.

In one or more embodiments, the lower connecting duct 125 may be connected to and in fluid communication with a transfer duct 130 that is connected to and in fluid communication with a source duct 140, and the source duct 140 may be connected to and in fluid communication with a heating fluid source 150, wherein the source duct 140, transfer duct 130, and lower connecting duct 125 comprise a delivery duct that defines a flow path for the heating fluid from the heating fluid source 150 to the lower calciner section 120.

In one or more embodiments, the calciner 100 may further comprise a T-duct 145 inserted between the source duct 140 and the transfer duct 130, such that the straight-through portion of the T-duct 145 is connected to and in fluid communication with the source duct 140 at one end and the transfer duct 130 at the opposite end to facilitate heating fluid flow with minimal pressure loss, and the intersecting branch 147 is connected to and in fluid communication with a by-pass duct 170. In various embodiments, the intersecting branch of the T-duct may be perpendicular or at an angle to the straight-through section of the T-duct to facilitate heating fluid flow to the exhaust.

In one or more embodiments, a calcining control valve 135 may be located in the heating fluid flow path after the T-duct 145 and before the lower connecting duct 125 to control the flow of heating fluid to the lower calciner section 120. In various embodiments a calcining control valve 135 may be inserted between the T-duct 145 and the transfer duct 130 to reduce the amount of dead volume between the T-duct and calcining control valve 135, where the calcining control valve 135 may be closed to block the flow of heating fluid to the lower calciner section 120. In various embodiments, the calcining control valve 135 can rapidly open and close (e.g., in less than 2seconds, or within 1 second, or in less than 1 second) to control heating fluid flow to the lower calciner section 120 and substrate 200.

In one or more embodiments, a by-pass control valve 175 may be located in the heating fluid flow path after the intersecting branch 147 of the T-duct 145 to control the flow of heating fluid to an exhaust. In various embodiments, a by-pass control valve 175 may be inserted between the intersecting portion of the T-duct 145 and the by-pass duct 170, where the by-pass control valve 175 may be closed to block the flow of heating fluid to the exhaust, so the heating fluid is directed to the calcining control valve 135 and/or transfer duct 130.

In one or more embodiments, the by-pass control valve 175 and the calcining control valve 135 may be automatic valves that can be triggered electrically or pneumatically. In various embodiments, the by-pass control valve 175 and the calcining control valve 135 may be triggered approximately simultaneously, so the flow path from the heating fluid source 150 to the lower calciner section 120 may be blocked at approximately the same time that the flow path from the heating fluid source 150 to the by-pass duct 170 is opened. This approximately simultaneous opening and closing of the by-pass control valve 175 and the calcining control valve 135 provides fast switching between the delivery of the heating fluid to a substrate in the calciner and the exhaust without having to power-up or power-down the heating fluid source 150 and/or one or more heating fluid pumps 160.

In various embodiments, the by-pass control valve 175 and/or the calcining control valve 135 may be cooled by passing cold air over the bearings.

In one or more embodiments, a heating fluid may be provided by a heating fluid source 150. In various embodiments, the heating fluid source 150 may comprise a combustion chamber 151 in which a fuel is burned in an incoming stream of air to produce a high temperature exhaust gas as the heating fluid. In various embodiments, the fuel may be natural gas introduced into the combustion chamber through a fuel line 157 to a burner 158. In various embodiments, an air inlet 155 may provide flow path for air for the combustion process, where the air inlet 155 may be coaxial with the fuel line 157 and/or burner 158. The air may be provided to the air inlet 155 by a heating fluid pump.

In various embodiments, the heating fluid source 150 may comprise an electrical heater system comprising electrical heater elements disposed within a heating chamber. In various embodiments, the electrical heater system may be a 100 Kw system.

In various embodiments, the heating fluid provided by the heating fluid source 150 may be an exhaust gas having a temperature in the range of about 400° C. to about 550° C., in the range of about 450° C. to about 550° C., or in the range of about 450° C. to about 540° C.

In one or more embodiments, the heating fluid source produces in the range of about 150,000 BTU (158,258,378 joules) to about 3400,000 BTU (358,718,990 joules). In various embodiments, the heating fluid source produces in the range of about 150,000 BTU (158,258,378 joules) to about 200,000 BTU (211,011,171 joules).

In one or more embodiments, the heating fluid may be a gas comprising oxygen (O₂), nitrogen (N₂), and carbon dioxide (CO₂). In various embodiments, the heating fluid may be a gas comprising oxygen (O₂), nitrogen (N₂), carbon dioxide (CO₂), carbon monoxide (CO), nitrogen oxides (NOₓ), and water (H₂O).

Under various operating conditions, NOₓ and/or CO may be delivered to a catalytic substrate as part of the heating fluid, wherein the NOₓ and/or CO may react with the catalytic material(s) deposited on the catalytic substrate to produce an exothermic reaction that further increases the temperature of the substrate.

In one or more embodiments, the incoming air stream may be provided to the heating fluid source 150 by one or more heating fluid pump(s) 160 in fluid communication with the heating fluid source 150 through an air infeed duct 165 and/or air inlet 155. In various embodiments, the heating fluid pump(s) 160 may be a blower or a compressor that can deliver air at a suitable flow rate and at a suitable pressure to the combustion chamber 150. In various embodiments, the blower or compressor produces a volumetric flow rate in the range of about 50 acfm to about 150 acfm, while maintaining a pressure in the range of about 5 inWG to about 20 inWG. The heating fluid volumetric flow rate and pressure is sufficient to at least propel the heating fluid through the heating fluid source 150, the ductwork 130, 140, 145, the valve 135, the substrate receiving portion 101, and a substrate 200 to the exhaust.

In various embodiments, the heat produced by the heating fluid source 150 may be adjusted to compensate for changes in the heating fluid flow to maintain the intended calcining temperature. In one or more embodiments, a heating fluid pump 160 is connected to and in fluid communication with a heating fluid duct 165, and the heating fluid duct 165 may be connected to and in fluid communication with a heating fluid source 150, wherein the heating fluid duct 165 defines a flow path for the heating fluid from the heating fluid pump 160 to the heating fluid source 150. In various embodiments, the heating fluid is air introduced into a combustion chamber 151, in which the air interacts with the fuel being combusted and additional combustion gases are introduced into the heating fluid.

In one or more embodiments, a heating fluid pump (not shown) is connected to and in fluid communication with an air inlet 155, and the air inlet 155 may be connected to and in fluid communication with a heating fluid source 150, wherein the air inlet 155 defines a flow path for air from the heating fluid pump to the heating fluid source 150.

In various embodiments, the various ducts and components, for example, the heating fluid duct 165, source duct 140, T-duct 145, transfer duct 130, lower connecting duct 125, upper calciner section 110, lower calciner section 120, and upper connecting duct 115 may be made of aluminum, steel, or stainless steel, where the material of construction is sufficient to handle the intended operating temperature of the particular duct or component.

The ducts may be thin-walled channel, tubing, and/or flexible tubing (e.g., bellows type). The ducts may have circular, square, rectangular, or other geometrical shaped cross-sections, but for convenience may be referred to as round or circular ducts herein. While particular duct sections and components may be separately identified and labeled, it should be understood that different sections of duct may be combined or fabricated into single unitary sections or further subdivided into smaller sections that may be commercially available or for ease of assembly, and such changes in construction and assembly are considered to be within the scope of the invention as set forth herein and in the claims. In addition, while particular duct sections and components are illustrated as being straight, curved, or having a relative size as illustrated, such depictions are intended for ease of presentation and discussion, and not intended to limit the principles or scope of the invention, for which reference should be made to the claims.

In various embodiments, the incoming air stream may be provided by two heating fluid pumps 160, where one of the heating fluid pumps 160 is a high capacity pump that provides greater than about 50% of the heating fluid flow volume, and the other heating fluid pump is a lower capacity pump that provides less than about 50% of the heating fluid flow volume, but provides more accurate flow control. In various embodiments utilizing two fluid pumps, the pumps may produce the same pressure to reduce or avoid back-flow in a lower pressure section of the ducts and/or components.

In various embodiments, the heating fluid pump may further comprise a differential pressure controller 162 and pressure transducer(s) 168 to maintain a constant flow rate for a pressure drop of 10 inWG (inches water gauge). The differential pressure controller 162 may adjust the heating fluid pump to propel more or less heating fluid through the heating fluid source depending on measured pressure difference.

In various embodiments, the output of the heating fluid pump(s) can overcome the pressure drops introduced by the components of the inline calciner and propel the heating fluid through the calcining system 100 and the substrate 200. In various embodiments, the output of the heating fluid pump(s) 160 is adjusted by the differential pressure controller 162 in electrical communication with the heating fluid pump(s) 160 and pressure transducer(s) 168. In various embodiments, two pressure transducers 168 are installed in the substrate-receiving portion 101 of the calciner, where one transducer is installed before the catalytic substrate and one transducer is installed after the substrate to measure the pressure drop introduced by the substrate. A first pressure transducer 168 may be inserted into the heating fluid flow at the lower connecting duct 125 or lower calciner section 120 to measure the heating fluid pressure before entering the channels of the catalytic substrate, and a second pressure transducer 168 may be inserted into the heating fluid flow at the upper connecting duct 115 or upper calciner section 110 to measure the heating fluid pressure after exiting the channels of the catalytic substrate 200.

In various embodiments, the one or more heating fluid pumps provide sufficient pressure to overcome the pressure drop introduced by a catalytic substrate held within the substrate-receiving portion 101 of the calciner, and deliver the hot heating fluid at a flow rate sufficient to raise the temperature of the catalytic substrate to the calcining temperature within about 0.5 second to about 12 seconds of processing, or about 7 seconds to about 10 seconds of processing, or about 9 seconds to about 10 seconds of processing cycle time.

In various embodiments, the pressure drop introduced by the catalytic substrate is in the range of about 6 inWG to about 12 inWG, or about 8 inWG to about 10 inWG, or about 10 inWG.

In various embodiments, the pressure generated by the heating fluid pump(s) is sufficient to overcome the pressure drop introduced by the catalytic substrate while maintaining an intended volumetric gas flow.

In various embodiments, the heating fluid source 150 is a hot air combustion system comprising a combustion chamber 151, a fuel line 157, and a burner 158, which may be a gas burner, a fuel oil or diesel fuel burner, or kerosene burner. In various embodiments, the burner may be multi-fuel burner connected to a suitable fuel source.

In various embodiments, the heating fluid source 150 comprises a combustion chamber 151 and a gas burner.

In various embodiments, the monolithic catalytic substrate may be in the calciner for a period of time in the range of about 0.5 seconds to about 4 seconds, or alternatively between about 1 second and about 3.5 seconds, or alternatively between about 2 seconds and about 3 seconds, or for about 1.5 seconds.

In one or more embodiments, the calcining system 100 may comprise a water reservoir 190 for storing and providing water to the heating fluid. In various embodiments, the water may be pumped by a water pump 180 from the reservoir 190 to an injection nozzle 185 inserted into a section of the source duct 140 to deliver a water spray or mist into the hot heating fluid flow. The injection nozzle 185 is connected to and in fluid communication with a water pump 180 and the water reservoir 190.

In one or more embodiments, a safety interlock comprising a water pump controller 187 in electrical communication with the water pump 180 and at least one temperature sensor 188 to detect the temperature of the heating fluid in the source duct 140, wherein the interlock prevents the water pump from operating and shuts the water pump 180 off if the temperature of the heating fluid and/or source duct 140 detected by the temperature sensor 188 is below the intended operating temperature mat be present.

Injected water may be volatilized and conveyed with the hot heating fluid to de-green a catalytic substrate while it is being calcined. In various embodiments, the water reservoir 190 may have sufficient capacity to store and provide 40 lbs./hour of water for at least 1 hour, at least 2 hours, at least 4 hours, or at least 8 hours to the to the injection nozzle 185 without being refilled. In various embodiments, the water may be deionized water. In various embodiments, the heating fluid from the heating fluid source and the vaporized water is conveyed to the inlet end of the lower calciner section through a delivery duct comprising a source duct 140, a transfer duct 130, and a lower connecting duct 125. In various embodiments, the delivery duct may further comprise a T-duct 145 and/or a calcining control valve 135.

In various embodiments, the intended operating temperature of the heating fluid for water injection is in the range of about 450° C. to about 550° C., and the heating fluid source may be at least about 165,000 BTU, or at least about 200,000 BTU or at least about 225,000 BTU.

In various embodiments, the transfers between one or more of the processing stations (e.g., staging area(s), weigh station(s), statistical processing control station(s), cooling stations, etc.) may be done by a person instead of a robot.

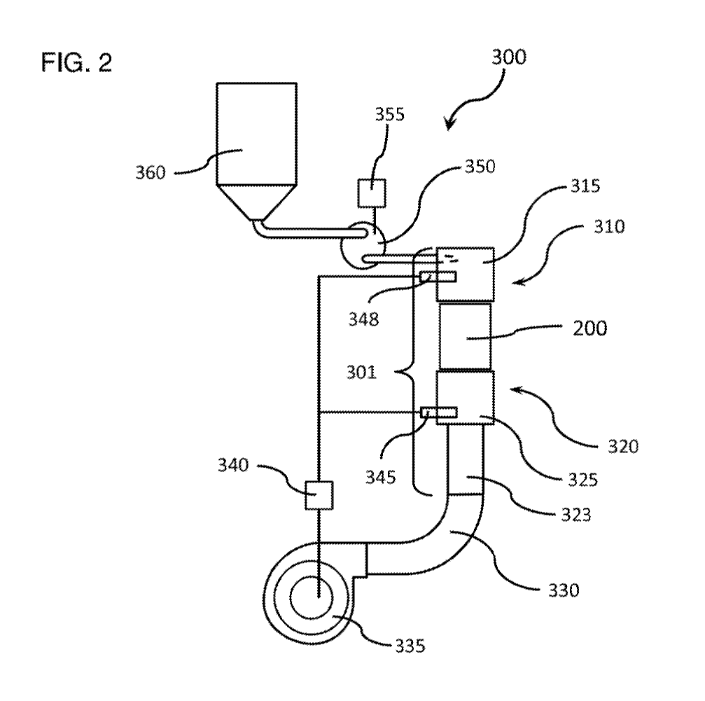

FIG. 2 illustrates an exemplary embodiment of an inline coating apparatus depicting a substrate-receiving portion for applying a metered coating to a substrate in an open position. In various embodiments, an inline coating apparatus may be configured to introduce a coating media into a plurality of channels of a substrate by forming a reservoir of coating media and adjusting a pressure applied to an end of the substrate, and/or adjusting a vacuum applied to an opposite end of the substrate, where the movement of the coating media into the channels of the substrate is controlled by the applied vacuum and/or pressure. In various embodiments, an inline coating apparatus may also be configured to apply pulse of gas through the cells of a substrate after coating, but before the substrate is transferred to a drying station.

In one or more embodiments, an inline coater module 300 may comprise a substrate-receiving portion 301 comprising a containment compartment 310 that is configured and dimensioned to fit over at least a portion of a catalytic substrate 200, and a pressure compartment 320 that is configured and dimensioned to fit over at least a portion of a catalytic substrate 200 to form an enclosed chamber. In various embodiments, the pressure compartment 320 fits over approximately a lower half of the catalytic substrate 200, and the containment compartment 310 fits over approximately an upper half of the catalytic substrate, when the catalytic substrate 200 is positioned vertically and horizontally so the longitudinal axis of the catalytic substrate is aligned with the longitudinal axis of the containment compartment 310 and pressure compartment 320.

In one or more embodiments, the pressure compartment 320 and containment compartment 310 are coaxial, and may move longitudinally relative to each other. In various embodiments, the longitudinal motion of the containment compartment 310 may be controlled by a linear actuator 313. In various embodiments, the longitudinal motion of the pressure compartment 320 may be controlled by a linear actuator (not shown) operatively associated with the pressure compartment housing 325. In various embodiments, the containment compartment 310 and/or pressure compartment 320 moves linearly between an open position and a closed position.

In one or more embodiments, the containment compartment 310 comprises a containment compartment housing 315, which forms a fluid-tight seal with the outside surface of the substrate 200, and pressure compartment housing 325 in a closed position. In various embodiments, the fluid-tight seal between the containment compartment 310 and the outside surface of the substrate 200 may be formed by a gasket between the containment compartment housing 315 and the outside surface of the substrate 200.

In one or more embodiments, the pressure compartment 320 comprises a pressure compartment housing 325, which forms a fluid-tight seal with the outside surface of the substrate 200, and the containment compartment housing 315 in a closed position. In various embodiments, the fluid-tight seal between the pressure compartment 320 and the outside surface of the substrate 200 may be formed by a gasket between the containment compartment housing 315 and the outside surface of the substrate 200.

In one or more embodiments, the containment compartment 310 retains a wet coating in contact with a top surface of the substrate 200, and the pressure compartment 320 communicates a pressurized gas evenly to the cells of the substrate 200 when in a closed position. In various embodiments, the pressure of the pressurized gas is sufficient to support the weight of the wet coating as a column above each of the cells of the substrate, so the wet coating does not wet the walls of the cells until the pressure is reduced or removed.

In one or more embodiments, the pressure compartment 320 is connected to and in fluid communication with a pressurized fluid source 335 through a connecting duct 330 and a telescoping sleeve 323 that connects the pressure compartment 320 to the connecting duct 330. In various embodiments, the pressurized fluid source 335 provides a gas at an adjustable pressure, and the pressure compartment 320 receives the pressurized gas from the pressurized fluid source 335 at an intended pressure sufficient to support a column of fluid equivalent to the weight of the wet coating in the containment compartment 310.

In one or more embodiments, the inline coater module 300 may comprise a pressure controller 340 operatively associated with the pressurized fluid source 335 that adjusts the pressure of the gas delivered to the pressure compartment. In various embodiments, the pressure controller 340 is electrically connected to the pressurized fluid source 335 and a pressure sensor 345 operatively associated with the pressure compartment 320.

In various embodiments, the inline coater module 300 may comprise a pressure sensor 345 operatively associated with the pressure compartment 320, which generates an inlet pressure value of the pressurized gas within the pressure compartment 320, and a fluid level transducer 348 operatively associated with the containment compartment 310, which generates a coating fluid level value of the wet coating within the containment compartment 310. The pressure controller 340 may be in electrical communication with the pressure sensor 345 and fluid level transducer 348, where the pressure controller 340 calculates the amount of wet coating in the containment compartment 310 and the inlet pressure value, and adjusts the pressurized fluid pump to propel more or less pressurized gas into the pressure compartment 320 depending on the pressure required to support the liquid head of the wet coating.

In one or more embodiments, the inline coater module 300 may comprise a catalytic coating source 360 connected to and in fluid communication with the containment compartment 310. In various embodiments, a wet coating pump 350 is connected to and in fluid communication with the catalytic coating source 360 and the containment compartment 310, where the wet coating pump 350 may deliver an intended amount of wet coating from the catalytic coating source 360 to the containment compartment 310. In various embodiments, a wet coating pump controller 355 turns the wet coating pump 350 on to pump an intended volume of wet coating. In various embodiments, the wet coating pump controller 355 may be in electrical communication with a fluid level transducer 348 to determine when the intended volume of wet coating is within the containment compartment 310. In various embodiments, the fluid level transducer operatively associated with the containment compartment detects the coating fluid level of the wet coating within the containment compartment, and sends a signal when the intended volume of wet coating is within the containment compartment 310.

In various embodiments, the wet coating may comprise a soluble catalytic precursor and/or catalytic slurry material. In various embodiments, the wet coating may comprise platinum group metals and/or base metals, and/or oxides of platinum group metals and/or base metals, one or more ceramic support material(s) and/or zeolites, and a carrier fluid, where the carrier fluid may comprise acetic acid.

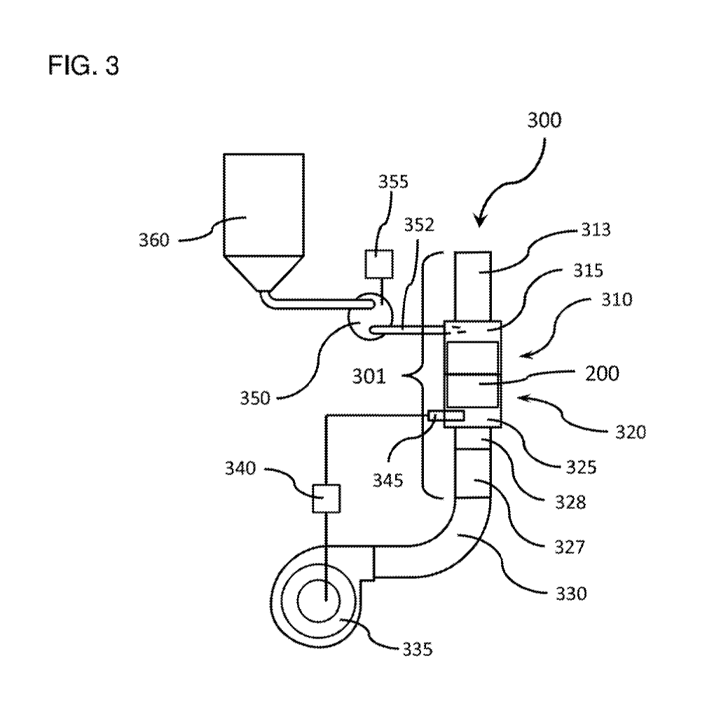

FIG. 3 illustrates an exemplary embodiment of an inline coating apparatus depicting a substrate-receiving portion in a closed position against a substrate gripper. In one or more embodiments, the apparatus for applying a metered coating to a substrate may be an inline coater module 300 in which a containment compartment 310 and a pressure compartment 320 of the substrate-receiving portion 301 are in a closed position encasing the catalytic substrate 200, so that pressure fluid conveyed from the pressurized fluid source 335 through the lower connecting duct 323 enters the interior volume of the pressure compartment housing 325, and enters the plurality of longitudinal cells of the catalytic substrate to support the wet coating in the containment compartment 310 above the substrate 200.

In an embodiment, the lower connecting duct 323 may comprise two or more concentric sleeves arranged in a telescoping manner to provide for linear movement of the pressure compartment 320, wherein the containment compartment 310 and/or pressure compartment 320 may be moved linearly to encase the catalytic substrate within the internal volume of the containment compartment housing 315 and/or pressure compartment housing 325.

In one or more embodiments, the containment compartment 310 may be operatively associated with a linear drive 313, so as to provide axial movement of the containment compartment 310. In one or more embodiments, the pressure compartment 320 may be connected to and in fluid communication with a lower connecting duct 323, wherein the lower connecting duct may allow axial extension of the pressure compartment 320, while maintaining a fluid-tight path to the lower calciner section 120. In various embodiments, the lower connecting duct 323 may be a bellows or an arrangement of concentric telescoping sleeves and/or ducts.

In one or more embodiments, the lower connecting duct 323 may comprise at least an outer sleeve 327 and an inner sleeve 328, wherein the inner sleeve 328 and outer sleeve 327 are configured and dimensioned to allow the inner sleeve to fit within and slidably engage the outer sleeve when the containment compartment 310 and pressure compartment 320 are in an open position for receiving a catalytic substrate 200.

In one or more embodiments, the lower connecting duct 323 may comprise an outer sleeve 327, an inner sleeve 328, and one or more intermediate sleeves configured and dimensioned to fit concentrically between the outer sleeve 327 and inner sleeve 328, so as to provide axial telescoping movement of the sleeves. In various embodiments, there may be a fluid-tight seal between each of the sleeves.

In one or more embodiments, the lower connecting duct 323 may be bellows that provides a fluid-tight flow path.

In operation, a catalytic substrate may be placed between the containment compartment 310 and pressure compartment 320, when the two sections are in an open position, where the catalytic substrate is axially aligned with and vertically positioned between the containment compartment 310 and pressure compartment 320. The containment compartment 310 and pressure compartment 320 may be coaxial, so longitudinal movement of the containment compartment 310 and pressure compartment 320 will close around the substrate 200 without experiencing interference with the outer edges and surfaces of the catalytic substrate.

In various embodiments, the substrate-receiving portion 301 is configured and dimensioned to have sufficient axial movement to provide clearance between a lower edge of a containment compartment housing 315 and an upper edge of a pressure compartment housing 325 for a catalytic substrate 200 having an particular height to be moved horizontally into position by a transfer mechanism, and aligned with the axis of the containment compartment 310 and pressure compartment 320. The clearance between a lower edge of a containment compartment housing 315 and an upper edge of a pressure compartment housing 325 is sufficient to avoid collision between the catalytic substrate 200 and the sides and/or edges of the containment compartment housing 315 and pressure compartment housing 325, when the catalytic substrate is being moved into or out of position.

In one or more embodiments, the pressure transducer(s) 345 may be operatively associated with the pressure compartment 320 to measure the pressure fluid pressure entering the channels of the catalytic substrate. The pressure measurement from the pressure transducer 345 may be used to calculate a pressure head to support the wet coating sitting on the top face of the substrate being coated by the pressure controller 340. The pressure controller 340 may adjust the flow and/or pressure of the pressure fluid being provided by the pressure fluid pump(s) 335 to prevent the wet coating from flowing into the substrate cells before an intended amount of wet coating has been delivered to the containment compartment 310. In various embodiments, the pressure in the pressure compartment 320 may be continuously monitored and adjusted in real time to compensate for the increasing weight of wet coating supplied to the containment compartment 310.

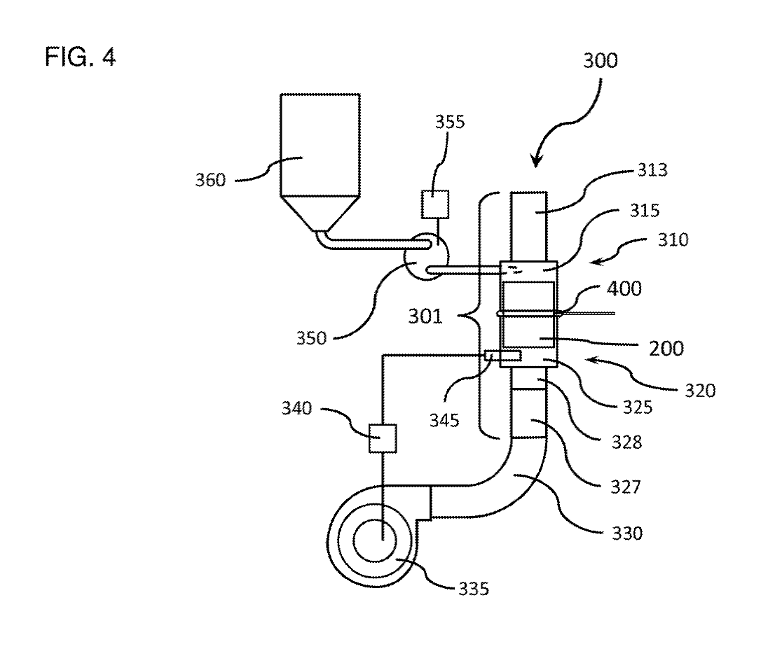

FIG. 4 illustrates an exemplary embodiment of an inline wet coating apparatus 300 depicting a substrate-receiving portion 301 in a closed position against a substrate gripper assembly 300. In one or more embodiments, the containment compartment 310 closes against a top face and pressure compartment 320 closes against a bottom face of a gripper assembly 300 to inhibit flow of pressure fluid around the outside of the catalytic substrate 200. In various embodiments, the clearance between the inside surface of the containment compartment 310 and the outer surface of the catalytic substrate 200 is about 0.5 inches or less, or about 0.25 inches or less. In various embodiments, the clearance between the inside surface of the pressure compartment 320 and the outer surface of the catalytic substrate 200 is about 0.5 inches or less, or about 0.25 inches or less.

In one or more embodiments, the lower connecting duct 323 may comprise thin-walled bellows that provide a fluid-tight seal between the interior volume and ambient atmosphere during longitudinal movement of the pressure compartment 320. The bellows forming the lower connecting duct 323 provides a fluid-tight flow path between the pressure compartment 320 and the transfer duct 330.

In one or more embodiments, the pressure fluid may flow through a connecting duct 330 to the internal volume of the pressure compartment housing 325. In various embodiments, the pressure fluid enters all of the cells of a catalytic substrate to provide a uniform pressure within each of the cells.

In one or more embodiments, a containment compartment 310 may comprise a containment compartment housing 315 having an outer wall and an interior area comprising an open volume, wherein the interior area may be configured and dimensioned to fit over at least a portion of a catalytic substrate 200.

In various embodiments, the interior area of the containment compartment housing 315 may have a cylindrical shape, a rectangular shape, a square shape, a hexagonal shape, a triangular shape, or other geometric shapes, which conform to a catalytic substrate having a particular shape. In various embodiments, the outer wall of the containment compartment housing 315 may have a cylindrical shape, a rectangular shape, a square shape, a hexagonal shape, a triangular shape, or other geometric shapes, wherein the outer wall of the containment compartment housing 315 may have a shape, which may conform to the particular shape of the interior area 116.

In various embodiments, the containment compartment 310 may further comprise a fluid level sensor 348 operatively associated with containment compartment housing 315.

In one or more embodiments the pressure compartment housing 325 may further comprise a transitional section having an outer wall, wherein the outer wall of the transitional section may be connected to the outer wall of the pressure compartment housing 325. In various embodiments the outer wall of the transitional section may be joined to the outer wall of the pressure compartment housing 325 for example by welding, or by mechanical fastening, or the outer wall of the transitional section and the outer wall of the pressure compartment housing 325 may be formed from the same piece of material to have a unitary construction.

In one or more embodiments, the transitional section may have an inside diameter at a first end and an inside diameter at a second end opposite the first end, wherein the inside diameter at the first end is smaller than the inside diameter of the second end. In various embodiments, the outer wall of the transitional section tapers from the first end to the second end. In various embodiments, transitional section may comprise a series of step-wise reductions in the inside diameter between the first end and the seconds end. In various embodiments, the second end of the transitional section is the end connected to the pressure compartment housing 325. In various embodiments, a pressure transducer 345 may be operatively associated with transitional section.

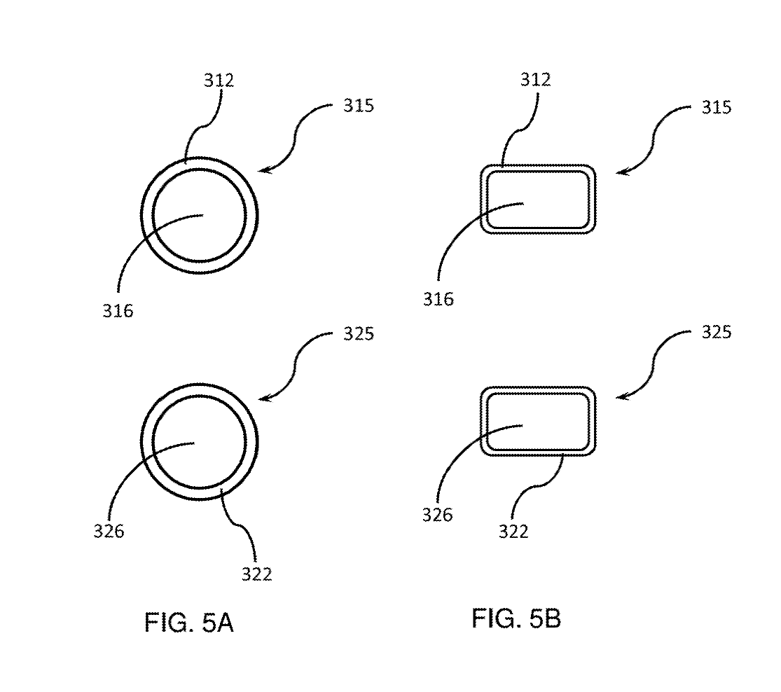

In one or more embodiments, a containment compartment housing 315 and a pressure compartment housing 325 may comprise a tubular wall 312 with a circular cross-section, as shown in FIG. 5A, having a height, wherein the height is sufficient to cover approximately half of the length of a catalytic substrate, and a cylindrical interior area forming an open interior volume 316 sized to receive at least a portion of a catalytic substrate.

In one or more embodiments, a containment compartment housing 315 and a pressure compartment housing 325 may comprise a tubular wall 312 with a rectangular cross-section, as shown in FIG. 5B, having a height, wherein the height is sufficient to cover approximately half of the length of a catalytic substrate, and a cylindrical interior area forming an open interior volume 316 sized to receive at least a portion of a catalytic substrate.

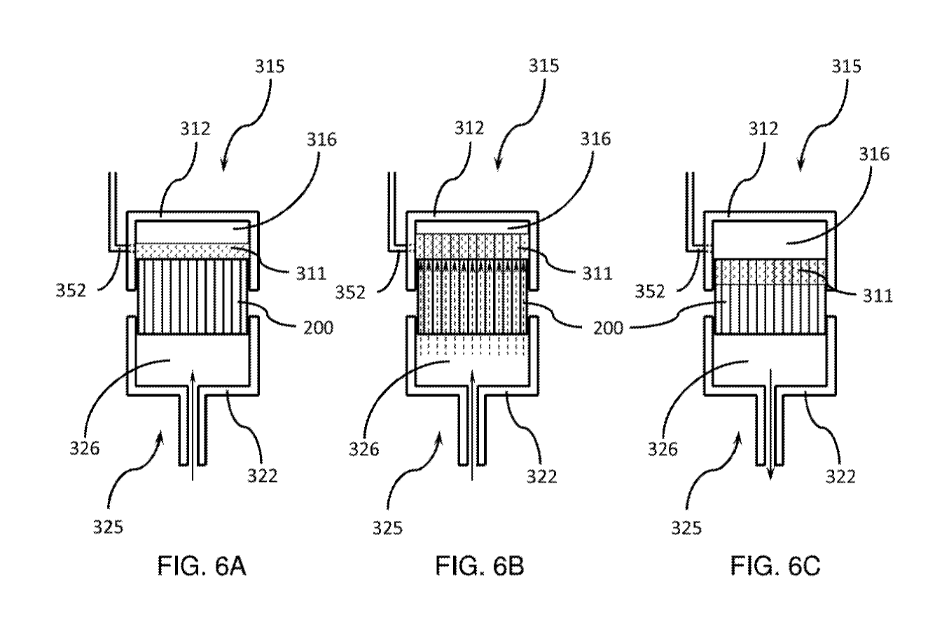

FIGS. 6A-C illustrate a wet coating process utilizing an exemplary inline coater module 300. FIG. 6A illustrates a containment compartment housing 315 and a pressure compartment housing 325 encasing a catalytic substrate 200. The catalytic substrate fits within the tubular wall 312 and takes up a portion of the internal volume 316.

In one or more embodiments, a wet coating 311 may be introduced into the internal volume 316 of the containment compartment housing 315 through a coating conduit 352 that is in fluid communication with a wet coating source. In various embodiments, an amount of wet coating 311 sufficient to coat an intended length of the cells of the substrate 200 is introduced into the internal volume 316. In various embodiments, a pressure fluid is introduced into the internal volume 326 of the pressure compartment housing 325 concurrently with the wet coating being introduced into the internal volume 316 of the containment compartment housing 315.

In one or more embodiments, a gasket or lip may form a seal between the inside surface of the containment compartment and the top and/or side surface of the substrate to prevent the wet coating from leaking down the side of the substrate.

FIG. 6B illustrates the continued influx of wet coating to the internal volume 316 of the containment compartment housing 315 until an intended level of wet coating is achieved, while the pressure of the pressure fluid within the internal volume 326 of the pressure compartment housing 325 is simultaneously increased to coincide with the increasing weight of wet coating accumulating above the top surface of the substrate.

In one or more embodiments, the viscosity and surface energy of the wet coating may also be adjusted to assist in balancing the capillary action and downward force of gravity and the upward force of the pressure of the pressure fluid in the cells of the substrate 200. In various embodiments, a column of the wet coating may be supported over each of the cells by a column of pressure fluid in the cells, where the pressure may be increased or decreased to prevent or control the flow of the wet coating into the cells of the substrate 200. In various embodiments, the flow rate of the wet coating into the substrate cells is controlled by the pressure of the pressure fluid, and/or applied vacuum.

FIG. 6C illustrates the flow of the wet coating an intended distance into the cells of the substrate. In one or more embodiments, once an intended level of wet coating 311 above the substrate is achieved in the containment compartment housing 315, the pressure of the pressure fluid in the cells of the substrate 200 may be reduced to allow the wet coating 311 to flow an intended distance into the cells, where the intended distance into the cells is determined by the initial height of the wet coating above the substrate. By uniformly reducing the pressure in the internal volume 326 of the pressure compartment housing 325, the pressure in each of the cells may be reduced uniformly, thereby providing an even flow of wet coating into each of the cells. This uniform control of the pressure allows each of the cells of the substrate 200 to be coated with essentially the same amount of coating, where “essentially the same” encompasses that there may be a slight distribution in local coating concentration and weight across the whole substrate surface, as well as slight variations in surface properties of each of the cells that affects the amount of wet coating entering each cell.

By avoiding applying a vacuum to suck the coating upwards into the cells, or application of pressure to force the wet coating downwards into the cells, blow-out may be avoided. In various embodiments, the catalytic substrate 200 may be loaded into the system robotically or by hand.

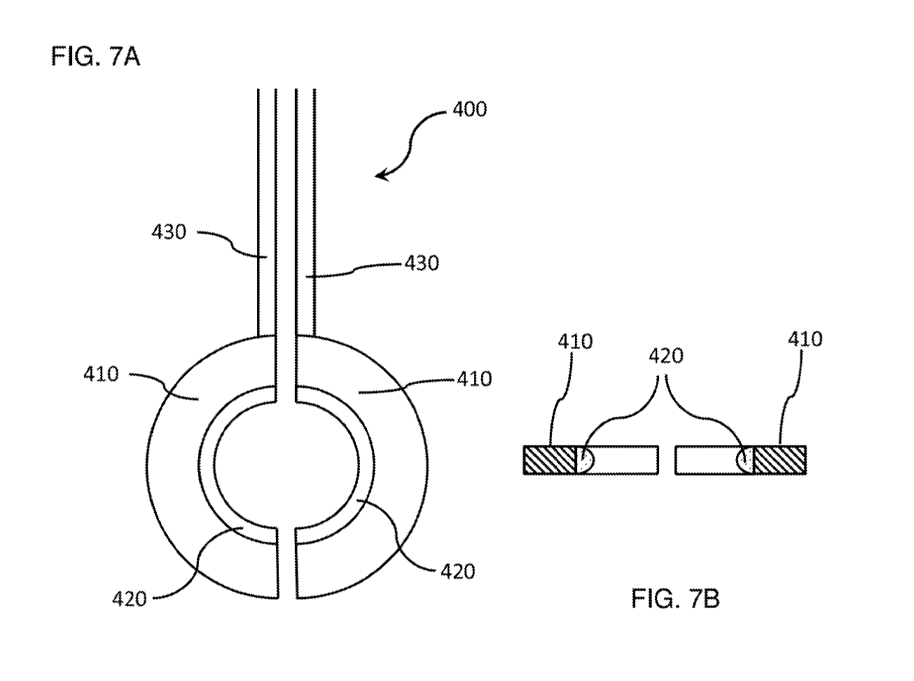

In one or more embodiments, the robotic transfer element may comprise a catalytic substrate gripper assembly 400, to grip and transport each substrate. FIG. 7A illustrates a top view of an exemplary embodiment of a gripper assembly 400 for holding a catalytic substrate. In various embodiments, the catalytic substrate gripper comprises two C-shaped rings 410 having an inside diameter sized to fit an intended catalytic substrate. In various embodiments, the insert 420 in each of the two C-shaped rings 410 is compressible and forms a fluid-tight seal around the outer shell of a catalytic substrate, when the substrate is being gripped. The gripper assembly may further comprise an arm 430 operatively associated with each of the C-shaped rings 410 to manipulate the rings and move a held substrate.

FIG. 7B illustrates a front cut-away view of an exemplary embodiment of a gripper assembly 400 for holding a catalytic substrate. In one or more embodiments, the catalytic substrate gripper assembly comprises a silicone rubber insert 420 that can operate continuously at a temperature of at least 600° F. In various embodiments, the insert and clamp assembly act as an insulator and heat sink for a short exposure time of <16 seconds.

In one or more embodiments, the catalytic substrate may be held in horizontal and vertical position by a catalytic substrate gripper assembly 400, while containment compartment 310 and pressure compartment 320 move longitudinally to envelope the catalytic substrate 200, where the lower edge of the outer wall 312 of the containment compartment housing 315 contacts a top face of the catalytic substrate gripper assembly 400, and the upper edge of the outer wall 322 of the pressure compartment housing 325 contacts a bottom face of the catalytic substrate gripper assembly 400.

In various embodiments, the lower edge of the outer wall 312 forms a fluid-tight seal with the top face of the two C-shaped rings 410 of the catalytic substrate gripper assembly 300, and the upper edge of the outer wall 322 forms a fluid-tight seal with the bottom face of the two C-shaped rings 410 of the bottom face of the catalytic substrate gripper assembly 400.

In one or more embodiments, the fluid-tight seals between the gripper rings 410 and the outer surface of the substrate 200, and the fluid-tight seals formed between the outer walls 312,322 of the housings 315,325 and the top and bottom surfaces of the gripper rings 410, prevents the pressure fluid from flowing around the catalytic substrate or exiting the pressure compartment 320. The insert may also be exposed to hot heating fluid in the driers and calciner during a processing cycle, and the temperature of the catalytic substrate, so is adapted to withstand the temperature to which it is exposed.

In various embodiments, the clearance between the inside surface of the upper calciner housing and the outer surface of the catalytic substrate calciner is minimized to reduce the amount of dead volume and heating fluid flowing along the outside of the catalytic substrate.

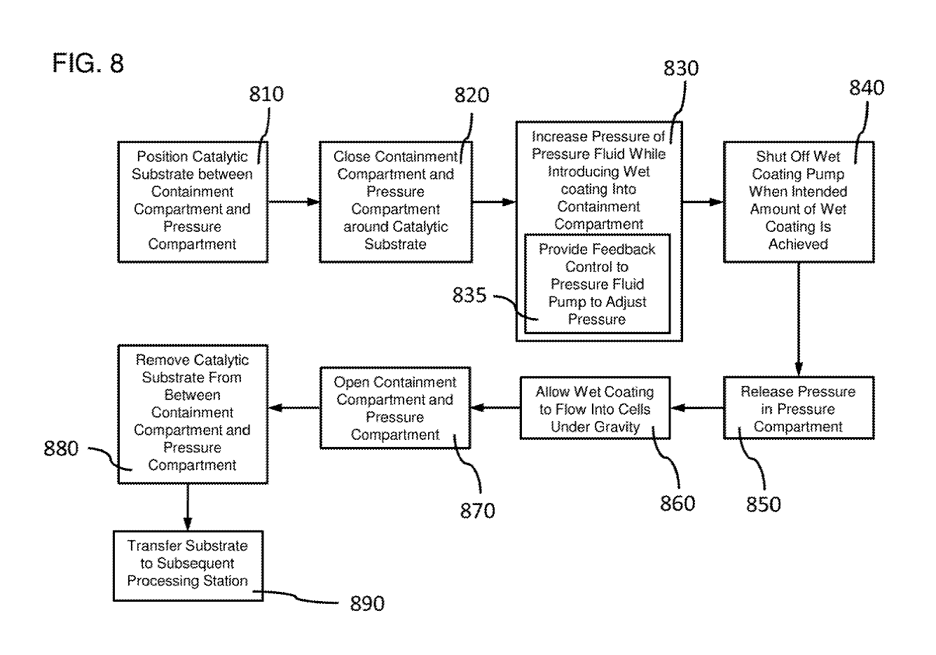

Principles and embodiments of the present invention relate to a method of introducing and affixing a catalytic coating to one or more faces of the cells of a catalytic substrate, wherein a catalytic coating may have been previously introduced into the interior of the catalytic substrate cells. FIG. 8 illustrates an exemplary embodiment of a method of coating a catalytic substrate.

At 810 a catalytic substrate is positioned within the substrate-receiving portion 301 of an inline coater module 300, and the longitudinal axis of the substrate is aligned with the longitudinal axis of the containment compartment 310 and pressure compartment 320 by a transfer mechanism. In one or more embodiments, a transfer mechanism may move a substrate from a preceding processing station and position the substrate between the containment compartment 310 and pressure compartment 320.

At 820 the containment compartment 310 and/or pressure compartment 320 may be moved linearly to close the containment compartment 310 and pressure compartment 320 around the catalytic substrate. In various embodiments, the containment compartment 310 and pressure compartment 320 may be sealed against a gripper of the transfer mechanism and against the surfaces of the substrate, wherein the substrate is encased in a fluid-tight chamber.

At 830 the pressure of the pressure fluid is increased essentially simultaneously (i.e., within the tolerances of the equipment) with the introduction of a wet coating into the containment compartment in a manner that balances the downward force of the wet coating on the cells of the substrate with the upward force of the pressure from the pressure fluid. In various embodiments, the pumping of wet coating into the containment compartment increases the weight of wet coating above the substrate, which increases the amount of pressure necessary to keep the wet coating out of the substrate cells. The inline coating apparatus may balance the increasing weight by increasing pressure.

At 835, the pressures measured by the pressure transducer(s) are used to calculate and/or adjust the output of the pressure fluid pump to maintain an increasing pressure taking into account the pressure drop across the catalytic substrate. In various embodiments, feedback is provided from a pressure transducer to a pressure fluid pump controller to adjust the pressure fluid pump.

At 840, the wet coating pump is shut off when an intended amount of wet coating has been conveyed to the containment compartment. A pump controller may be in electrical communication with a fluid level sensor that can detect the height of fluid in the containment compartment. The pump controller may shut off the pump when the fluid level detector indicates that the intended amount of wet coating is in the containment compartment.

At 850, the pressure fluid pump is slowed or stopped, and the pressure of the pressure fluid within the pressure compartment is allowed to decrease. Release of the pressure within the pressure compartment may be accomplished by opening a bleed valve.

At 860, the release of the pressure in the pressure compartment unbalances the forces maintaining the wet coating outside of the substrate cells and allows the wet coating to flow into the cells under gravity. In various embodiments, the wet coating will flow a distance into the cells determined by the amount of wet coating initially held above the substrate. Since the same amount of wet coating is above each cell, the length of cell wall coated by the wet coating should be essentially equal for all the cells.

At 870, the substrate-receiving portion 301 of an inline coater module 300 is opened by moving the containment compartment and/or pressure compartment linearly away from the other opposing compartment along its/their longitudinal axis. The containment compartment and pressure compartment may be moved far enough away from each other to provide clearance for the transfer mechanism to remove the substrate from the inline coater module, where the transfer mechanism moves horizontally.

At 880, the catalytic substrate is removed from between the containment compartment and the pressure compartment by the transfer mechanism. In one or more embodiments, a transfer mechanism comprises a gripper that holds the catalytic substrate in a vertical orientation, and move horizontally from process station to process station in a multi-station coater system. In various embodiments, the gripper comprises an arm that extends from a continuous drive mechanism that forms an oval path.

At 890, the catalytic substrate may be transferred to a subsequent station to be weighed, dried, and/or calcined. In various embodiments, the process of coating a catalytic substrate is only one part of an overall process of producing a finished catalytic substrate which may further comprise weighing, drying, and calcining In addition, a cycle of coating, weighing, drying, calcining, and combinations thereof, may be repeated one or more times to produce a catalytic substrate with multiple catalytic coatings and/or multiple layers of catalytic coatings.

Another aspect of the present invention relates to a method for coating a substrate having a plurality of channels with a coating media comprising: a) partially immersing the substrate into a vessel containing a bath of the coating media, said vessel containing an amount of coating media in excess of the amount sufficient to coat the substrate to a predetermined level; b) applying a vacuum to the partially immersed substrate at an intensity and a time sufficient to draw the coating media upwardly from the bath into each of the channels for a distance which is less than the length of the channels to form a uniform coating profile therein; or c) applying a vacuum to the partially immersed substrate at an intensity and time sufficient to draw the coating slurry upwardly from the bath into the interior of the plurality of substrate cells; rotating the substrate 180° around a transverse axis; and then applying a blast of air to the end of the substrate which had been immersed into the slurry to distribute the catalytic composition there within. “Vacuum” and “pressure” should be understood as relative to direction of flow, either push or pull with or against gravity, and may be measured against atmospheric pressure, where a vacuum is a force below atmospheric pressure. The pressure and/or vacuum may be measured in inches water gauge, as known in the art. A solution or slurry may be similar as both produce an oxide coating layer upon calcination, where a solution contains soluble salts and a slurry contains dispersed inorganic oxide(s) and or mixtures of soluble and insoluble species.

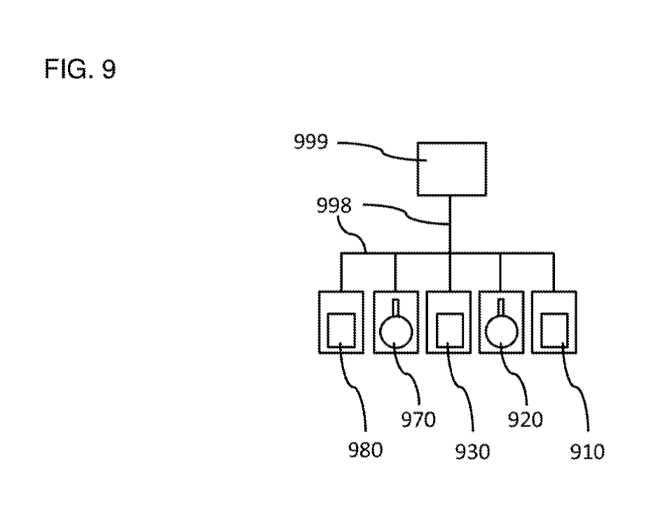

An aspect of the present invention relates generally to a modular, multi-station, coater system for preparing a catalytic substrate. FIG. 9 illustrates an exemplary embodiment of a multi-station coater system.

In one or more embodiments, a multi-station coater system 900 may comprise a raw weight station 910, wherein an initial weight of a substrate is measured, a first coating station 920, where a wet coating is introduced into the longitudinal cells of the substrate, a first wet weight station 930, wherein a wet weight of the substrate is measured, a first inline calciner module 970, where the catalytic coating is calcined on the substrate, and a first calcined weight station 980, wherein a calcined weight of a substrate is measured.

In various embodiments, a substrate may initially be weighed on the raw weight station 910 before any other processing steps to determine a baseline dry weight of the unprocessed substrate for comparison with substrate weights after the deposition of one or more catalytic coatings. The changes in weight may be used to calculate the amount of catalytic material(s) deposited on the walls of the substrate cells, and to determine if the substrate is within specification, while it is a work in progress, rather than a final product that may be out of specification. In various embodiments, the raw weight station 910, the wet weight station 930, and/or the calcined weight station 980 may be a digital scale that may be connected to and in electrical communication with a controller 999 over a communication path 998.

In one or more embodiments, a scale may be operatively associated with the calcining apparatus to determine the wet weight of a catalytic substrate after the application of the coating liquid to the catalytic substrate. A measure of the additional weight of the catalytic substrate after application of the washcoat may be calculated by the difference between the initial dry weight of the substrate and the wet weight measured by respective scales, to determine whether a correct amount of coating liquid was applied.

In one or more embodiments, a scale may be operatively associated with the calcining apparatus to determine the weight of a catalytic substrate prior to the calcining of the washcoat to the face of the substrate cell walls.

In various embodiments, a scale may be operatively associated with the calciner to determine if the post-calcining weight falls within intended limits. If it is determined that a catalytic substrate has a weight after calcining that is outside intended limits, the catalytic substrate processing may be interrupted to allow adjustments, calibrations, and/or maintenance before additional substrates that may be out of specification are produced.

In various embodiments, the catalytic substrate may be weighed on a first scale to obtain an intermediate or wet weight prior to calcining, wherein the scale may comprise a computer and/or a memory configured to receive and store weight values obtained for a catalytic substrate, or the scale may be in electronic communication with a computer and/or a memory configured to receive and store weight values obtained for a catalytic substrate. The catalytic substrate may be removed from the calcining apparatus and placed on a second scale by a robot.

In various embodiments, a controller 999 may be a computer configured to receive electric signals and/or information, store such received information, perform calculations on received, stored and/or programmed information, and send signals to other components connected to and in electrical communication with a controller over a communication path 998.

In various embodiments, a substrate may be weighed after each processing stage to provide statistical process control and/or process feedback to adjust the various processing parameters (e.g., wet coating viscosity, PGM concentration, ratio of slurry to carrier, drying time, calcining temperature, etc.) at each respective process station. Variations in the process(es) may thereby be followed as multiple substrates are processed by the system, and adjustments made to each of the inline stations and/or out-of-specification substrates removed from the processing sequence before additional time, energy, and expensive materials may be wasted on a defective or otherwise unusable substrate. By correcting deviations in the processing parameters and specifications in real time before a coating or substrate is out-of-specification, scrap may be reduced and the total throughput of the multi-station coater system increased, so at least about 25%, about 50% or even about 100% more finished in-specification catalytic substrates are produced per unit time period (e.g., units per hour) than a coating system that operates in a batch-wise manner (i.e., a block of substrates are completed before testing and/or changes are made to the system).

In one or more embodiments, the substrate may have a first wet coating introduced into the cells of the substrate by a first coating station 920 to deposit a first catalytic coating (e.g., PGM with or without a support material) over at least a portion of the walls of the cells. In various embodiments, the first coating station 920 may be a metered coating apparatus as described herein, where the wet coating flows down into the cells under gravity, capillary forces, and/or vacuum.

In one or more embodiments, the substrate may be weighed on the first wet weight station 930 after the wet coating has been introduced into the substrate. The wet weight may be compared to the initial weight to calculate the actual amount of wet coating introduced into the substrate. If the actual amount of wet coating is greater or less than the intended amount, an operator may be alerted to the out-of-specification character of the substrate by an alarm, or the substrate may be discharged from the coater system. By identifying and removing an out-of-specification substrate before additional processing is conducted, the number of scrap substrates may be reduced and the total output of the coater system can be increased.

In various embodiments, a substrate may be calcined in a first inline calciner module 970 after the wet coating has been introduced into the substrate. The catalytic coating may be calcined onto the surface(s) of the cells to provide a substrate with at least a portion of a bottom coat. In various embodiments, the wet coating may be dried to remove at least a portion of the carrier fluid prior to being calcined. Removal of a sufficient amount of the carrier fluid allows the catalytic coating portion (i.e., slurry solids) to be retained on the surface(s) of the cells without dripping or running. Calcining of a catalytic coating may drive off remaining carrier fluid, thermally affix the catalytic coating on the cell walls, and/or convert the chemical structure (e.g., phase transition) and/or formula (e.g., chemical decomposition) of at least some of the catalytic coating.

In a non-limiting example, a catalytic substrate comprising a dry washcoat layer deposited on a plurality of cell walls is received by the inline calciner module 970, the upper calciner section and lower calciner section move axially to encase the catalytic substrate, a heating fluid having a temperature in the range of about 465° C. and about 550° C. is passed through the cells of the catalytic substrate at a flow rate in the range of about 200 acfm to about 400 acfm for a time period in the range of about 8 seconds to about 12 seconds to calcine the deposited washcoat on the catalytic substrate. In some embodiments, a calciner module may also be referred to as a calcining station.

In one or more embodiments, the calcined substrate may be weighed on the first calcined weight station 980 after the catalytic coating has been calcined on the substrate. The actual amount of catalytic coating deposited onto the walls of the cells may be calculated by comparing the initial weight of the substrate to the calcined weight of the substrate. The changes in weight may be used to calculate the amount of calcined catalytic material(s) (e.g., PGM and support, metal and molecular sieve, etc.) deposited on the walls of the substrate cells, and to determine if the weight of the calcined substrate is within specification before additional wet coatings are introduced into the substrate. If the actual amount of catalytic coating is greater or less than the intended amount, an operator may be alerted to the out-of-specification character of the substrate by an alarm, or the substrate may be discharged from the coater system. In various embodiments, an audible and/or visual signal may alert an operator that a substrate is out-of-specification, and/or the substrate may be physically ejected by the transfer mechanism or an ejection mechanism incorporated into or operatively associated with a weight station, where for example the transfer mechanism may open to allow the substrate to fall into a bin or the ejection mechanism is a push bar or air jet that forces a substrate off the scale into a bin.

An aspect of the present invention also relates to a system for preparing a catalytic substrate, comprising a first catalytic substrate coating station that applies at least one washcoat, also referred to as a wet coating, comprising a catalytic slurry and a liquid carrier to at least a portion of the catalytic substrate, at least one drying station that removes at least a portion of the liquid carries from the at least a portion of the catalytic substrate, one or more calcining stations comprising an upper calciner section and a lower calciner section, wherein the upper calciner section and the lower calciner section are configured and dimensioned to fit over the catalytic substrate and form a fluid-tight seal, and a heating fluid source that supplies a volume of heating fluid at an intended temperature operatively associated with the lower calciner section, wherein the heating fluid is delivered to an inlet end of the lower calciner section to calcine the catalytic slurry of the washcoat to the cell walls of the catalytic substrate, and a substrate gripper that holds the catalytic substrate and transfers the catalytic substrate between the catalytic substrate coating station, the at least one drying station, and the one or more calcining stations, wherein one calcining station of the one or more calcining stations is adjacent to one of the at least one drying stations.

In various embodiments, the system further comprises a second catalytic substrate coating station that applies at least one additional washcoat comprising a catalytic slurry and a liquid carrier to at least a portion of the catalytic substrate after the catalytic substrate has been calcined at least once at the one or more calcining station, and at least one weighing station that measures the weight of the catalytic substrate, wherein the substrate gripper transfers the catalytic substrate from the catalytic substrate coating station, the drying station, or the calcining station to the at least one weighing station to determine a wet and/or a dry weight of the catalytic substrate.

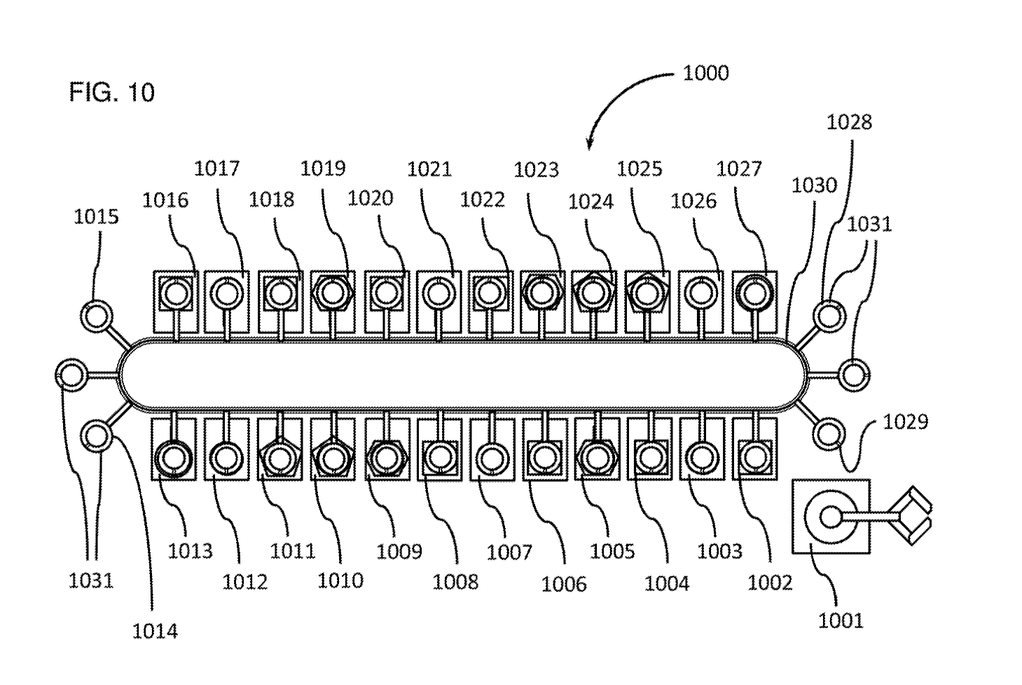

An aspect of the present invention relates generally to a modular, multi-station, coater system for applying a plurality of washcoats to a catalytic substrate. FIG. 10 illustrates another exemplary embodiment of a multi-station coater system.

In one or more embodiments, the multi-station coating system 1000 may comprise a raw weight station 1002 that weighs the catalytic substrate before it is processed, a first catalytic substrate coating station 1003 that applies a first washcoat, a first wet weight station 1004 that weighs the washcoated substrate, a first drying station 1005 that removes at least a portion of the liquid carrier, a first dry weight station 1006 that weighs the dried substrate, a first inline calcining station 1013 that calcines the washcoat onto the substrate, and a first calcined weight station 1016 that weighs the calcined substrate. In various embodiments, the first dry weight station 1006 measures the weight of the washcoated substrate to determine if an intended amount of catalytic coating has been applied to the walls of the substrate cells by the first catalytic substrate coating station 1003. In various embodiments, the various stations may comprise two or more heads, where each head may separately process an individual catalytic substrate at the same time. In various embodiments, two or more catalytic substrates may be processed at each station during one processing cycle, and then transferred in tandem to the next station.

In one or more embodiments, the multi-station coating system may further comprise a loading apparatus 1001, which may be a robotic arm, as would be known in the art, where the loading apparatus 1001 introduces substrates sequentially into the multi-station coating system 1000. In various embodiments, a substrate is taken from the loading apparatus 1001 and gripped by a gripper assembly 1031 moving between stations of the multi-station coating system. In various embodiments, two or more grippers may be load and then proceed to a multi-head station to begin processing. Weight stations may comprise two or more scales for simultaneously weighing two or more catalytic substrates.

In one or more embodiments, the multi-station coating system further comprise a first drying station 1005, which may be a first finesse drying station or first multi-phase drying station, subsequent to the first wet weight station 1004. In various embodiments, a finesse drying station may be configured to deliver hot air to the substrate at a single intended finesse temperature and a single intended finesse flow rate. In various embodiments, an intermediate drying station may be configured to deliver hot air to the substrate at a single intended intermediate temperature and a single intended intermediate flow rate, where the intended intermediate temperature and/or intermediate flow rate may be greater than the finesse temperature and/or finesse flow rate. In various embodiments, a final drying station may be configured to deliver hot air to the substrate at a single intended final temperature and a single intended final flow rate, where the intended final temperature and/or final flow rate may be greater than the intermediate temperature and/or intermediate flow rate.

In various embodiments, a multi-phase drying station may be configured to combine the function of a finesse drier, an intermediate drier, and/or a final drier into a single station configured to deliver hot air to the substrate at one or more incremental, intended temperature(s) and/or one or more incremental, intended flow rates, where the changes in temperature(s) and flow rates may be ramped or discrete.

In various embodiments, a multi-stage drying station may be configured to have adjustable fan speeds and/or heat output. In various embodiments, a multi-stage drying station may comprise two or more station heads, where each station head is configured to receive a substrate. In various embodiments, the first drying station 1005 introduces hot air into the longitudinal cells of the catalytic substrate to evaporate at least a portion of the carrier liquid from the washcoat, where the hot air passes through the cells of the washcoated substrate from a first end to a second end. In various embodiments, the temperature of the hot air introduced to the substrate by the drying station 1005 may be in the range of about 100° C. (212° F.) to about 177° C. (350° F.), or at about 149° C. (300° F.) at a flow rate in the range of about 600 acfm to about 900 acfm for about 8 to 10 seconds. In one or more embodiments, the multi-stage drying station may monitor the temperature and/or relative humidity of the exiting hot air to determine the extent to which a substrate has been dried.

In various embodiments, the first drying station 1005 produces an at least substantially dried substrate, where “substantially dried” is indicated by about 50% to about 75% of the liquid carrier being removed from the cells. In various embodiments, the multi-station coating system may further comprise a dry weight station 1006 subsequent to the drying station 1005.

In one or more embodiments, the multi-station coating system 1000 may further comprise a second catalytic substrate coating station 1007, where a second wet coating comprising a second catalytic coating and a second carrier liquid is introduced into the substrate. In various embodiments, the catalytic substrate may be flipped between the first catalytic substrate coating station 1003 and the second catalytic substrate coating station 1007, so an uncoated portion of the catalytic substrate may be positioned within a containment compartment of the second catalytic substrate coating station 1007 and coated with the second washcoat. In various embodiments, the multi-station coating system may further comprise a second wet weight station 1008 subsequent to the second catalytic substrate coating station 1007, where the wet weight of the substrate is measured after the second washcoat is applied.

In one or more embodiments, the multi-station coating system may further comprise a second drying station 1009, which may be a second multi-phase drying station or second finesse drying station, subsequent to the second wet weight station 1008. In various embodiments, a second drying station 1009 introduces hot air into the cells of the catalytic substrate to evaporate at least a portion of the carrier liquid from the washcoat. The temperature of the air introduced to the substrate by the second drying station 1009 may be in the range of about 100° C. (212° F.) to about 177° C. (350° F.), or in the range of about 121° C. (250° F.) to about 149° C. (300° F.) at a flow rate in the range of about 400 acfm to about 500 acfm for about 8 to 10 seconds.

In one or more embodiments, the multi-station coating system may further comprise a first intermediate drying station 1010, subsequent to the second finesse drying station 1009. The temperature of the air introduced to the substrate by the first intermediate drying station 1010 may be in the range of about 149° C. (300° F.) to about 205° C. (400° F.) at a flow rate in the range of about 600 acfm to about 900 acfm for about 8 to 10 seconds.

In one or more embodiments, the multi-station coating system may further comprise a first final drying station 1011, subsequent to the first intermediate drying station 1010. The temperature of the air introduced to the substrate by the final drying station 1010 may be in the range of about 149° C. (300° F.) to about 205° C. (400° F.) at a flow rate in the range of about 1000 acfm to about 2500 acfm for about 8 to 10 seconds. In various embodiments, the intermediate drying station 1010 and/or final drying station 1011 may not be included if a multi-phase drying station configured to perform the drying stages of an intermediate drying station 1010 and/or final drying station 1011 is present upstream in the multi-station coating system.

In one or more embodiments, the multi-station coating system may further comprise a first dry weight station 1012, that weighs the dried substrate before calcining to determine if an intended amount of catalytic coating has been applied to the walls of the substrate cells by the second catalytic substrate coating station 1007.

In various embodiments, the first calcined weight station 1016 measures the weight of the washcoated and calcined substrate to determine if an intended amount of catalytic coating has been applied to the walls of the substrate cells by the second catalytic substrate coating station 1007 and/or the first catalytic substrate coating station 1003.

In various embodiments, the coating system may further comprise a first cooling station 1014, where the temperature of the calcined substrate decreases to an intermediate temperature between the calcining temperature and room temperature, and a second cooling station 1015, where the temperature of the calcined substrate further decreases from the intermediate temperature to room temperature.

In one or more embodiments, the multi-station coating system may further comprise a third catalytic substrate coating station 1017 that applies a third washcoat comprising a third catalytic slurry and a third liquid carrier to at least a portion of the catalytic substrate, a third drying station 1019 that removes at least a portion of the liquid carrier from at least a portion of the catalytic substrate, and a second inline calcining station 1027. In various embodiments, the catalytic substrate may be flipped between the second catalytic substrate coating station 1007 and the third catalytic substrate coating station 1017, so the third washcoat may be applied as a first top coat over at least a portion of the substrate previously coated with the first washcoat.

In one or more embodiments, the multi-station coating system may further comprise a third wet weight station 1018 subsequent to the third catalytic substrate coating station 1017 and preceding the third drying station 1019, where the wet weight of the substrate is measured after the third washcoat is applied.

In one or more embodiments, the third drying station 1019 may be a third multi-phase drying station 1019 subsequent to a third wet weight station 1018 and preceding the second calcining station 1027, where the carrier liquid of the third washcoat is at least partially evaporated from the longitudinal cells of the substrate to produce an at least substantially dried substrate. In various embodiments, the wet coating may comprise a catalytic coating including a catalytic material (e.g., PGM, transition metal, etc.) and a support material (e.g., titania, alumina, etc.), and a carrier liquid (e.g., water, ethylene glycol, etc.) that may be combined to form a slurry. In various embodiments, a sufficient amount of carrier liquid may be removed from the wet coating by a third multi-phase drying station 1019 to minimize or prevent the catalytic coating from dripping or running down the walls of the substrate cells.

In one or more embodiments, the multi-station coating system may further comprise a third dry weight station 1020 subsequent to the third drying station 1019, that weighs the dried substrate after the third washcoat is applied to the substrate and before calcining to determine if an intended amount of catalytic coating has been applied to the walls of the substrate cells by the third catalytic substrate coating station 1017.

In various embodiments, the first inline calcining station 1013 and/or second inline calcining station 1027 may comprise a substrate-receiving portion comprising an upper calciner section and a lower calciner section, wherein the upper calciner section and the lower calciner section are configured and dimensioned to fit over the catalytic substrate and form a fluid-tight seal against each other or against a gripper assembly, and a heating fluid source that supplies a volume of heating fluid at an intended temperature operatively associated with the lower calciner section, wherein the heating fluid is delivered to an inlet end of the lower calciner section to calcine the catalytic slurry of the washcoat to the cell walls of the catalytic substrate, and a substrate gripper that holds the catalytic substrate and transfers the catalytic substrate between the catalytic substrate coating station, the at least one drying station, and the one or more calcining stations, wherein one calcining station of the one or more calcining stations is adjacent to one of the at least one drying stations.

In various embodiments, the coating system may further comprise a fourth catalytic substrate coating station 1021 that applies a fourth washcoat comprising a catalytic slurry and a liquid carrier to at least a portion of the catalytic substrate after the catalytic substrate has been calcined at least once at the first inline calcining station 1013. In various embodiments, the coating system may further comprise a fourth wet weight station 1022 subsequent to the fourth catalytic substrate coating station 1021 and preceding a fourth drying station 1023, where the wet weight of the substrate is measured after the fourth washcoat is applied. In various embodiments, the catalytic substrate may be flipped between the third catalytic substrate coating station 1017 and the fourth catalytic substrate coating station 1021, so the fourth washcoat may be applied over at least a portion of the substrate previously coated with the second washcoat. In various embodiments, the catalytic substrate may have one, two, three, and/or four washcoats applied to the cell walls.

In one or more embodiments, the multi-station coating system may further comprise a fourth drying station 1023 that removes at least a portion of the liquid carrier from at least a portion of the catalytic substrate, where the carrier liquid of the fourth washcoat is at least partially evaporated from the longitudinal cells of the substrate to produce an at least substantially dried substrate.

In one or more embodiments, the multi-station coating system may further comprise a second intermediate drying station 1024, subsequent to the fourth drying station 1023. The temperature of the air introduced to the substrate by the fourth intermediate drying station 1024 may be in the range of about 149° C. (300° F.) to about 205° C. (400° F.) at a flow rate in the range of about 600 acfm to about 900 acfm for about 8 to 10 seconds.

In one or more embodiments, the multi-station coating system may further comprise a second final drying station 1025, subsequent to the second intermediate drying station 1024. The temperature of the air introduced to the substrate by the second final drying station 1025 may be in the range of about 149° C. (300° F.) to about 205° C. (400° F.) at a flow rate in the range of about 1000 acfm to about 2500 acfm for about 8 to 10 seconds.

In one or more embodiments, the multi-station coating system may further comprise a fourth dry weight station 1026, that weighs the dried substrate before a second calcining to determine if an intended amount of catalytic coating has been applied to the walls of the substrate cells by the fourth catalytic substrate coating station 1021 and/or third catalytic substrate coating station 1017.

In various embodiments, the coating system may further comprise a third cooling station 1028, where the temperature of the calcined substrate decreases to an intermediate temperature between the calcining temperature and room temperature, and a fourth cooling station 1029, where the temperature of the calcined substrate further decreases from the intermediate temperature to room temperature. In various embodiments, the completed and cooled catalytic substrate may be removed from the fourth cooling station by the loading apparatus 1001 for transport to other locations (e.g., quality control-testing, packaging, shipping).

In various embodiments, the at least one weighing station(s) comprise a scale that measures the weight of the catalytic substrate, wherein the substrate gripper transfers the catalytic substrate from the catalytic substrate coating station, the drying station, or the calcining station to the at least one weighing station to determine a wet, intermediate, and/or a dry weight of the catalytic substrate, where a wet weight is a weight of a substrate coated with a washcoat before any removal of the carrier, an intermediate weight is after at least a portion of the liquid carrier has been removed by drying the substrate and washcoat, and a dry weight may be after essentially all the liquid carrier has been removed by drying or after calcining a coated substrate. In various embodiments, each of the at least one weighing station(s) may be in electrical communication with a controller over a communication path, which may be hard-wired or wireless, to send electronic data relating to the measured weights of the substrate(s) to the controller. In various embodiments, the controller may be in electrical communication with the other various stations described herein over a communication path, which may be hard-wired or wireless, to receive electronic data relating to the measured weights of the substrate(s) and send electronic signal relating the various operating parameters to the stations.

In various embodiments, the controller may be in electrical communication with the pressure controller operatively associated and in fluid communication with the pressurized gas source and pressure compartment, where the controller sends electric signals to the pressure controller to adjust the gas pressure in the pressure compartment. In various embodiments, the controller may be in electrical communication with the wet coating pump controller and fluid level transducer, where the controller sends electric signals to the wet coating pump controller to start or stop the wet coating pump to increase the amount of wet coating in the containment compartment.

In one or more embodiments, the coating system may further comprise a transfer mechanism 1030 comprising a plurality of gripper assemblies 1031 where each gripper assembly may hold a catalytic substrate and move the catalytic substrate(s) from one station to the next. In various embodiments, the substrate may be moved by the transfer mechanism intermittently with a period between movements in the range of about 8 seconds to about 12 seconds.

In one or more embodiments, the multi-station coater system is a modular multi-station coater system, where various stations may be inserted or removed to add or eliminate various processes from the system and the transfer mechanism may be lengthened or shortened to accommodate the change in the number of stations.

In one or more embodiments, the multi-station coater system produces about 360 to about 500 catalytic substrate an hour. In one or more embodiments, the multi-station coater system produces about 400 to about 450 catalytic substrate an hour. In various embodiments, the multi-station coater system produces about 420 to about 450 catalytic substrates an hour with one pass around the multi-station coater system without off-line calcining In various embodiments, the multi-station coater system may apply 2 full washcoats (or 4 partial washcoats) to a substrate in making one revolution around the multi-station coater system 1000. In various embodiments, one completed catalytic substrate comes off the multi-station coater system every 8 seconds to about every 12 seconds. In various embodiments comprising multi-head stations, two or more completed catalytic substrates may come off the multi-station coater system about every 16 seconds to about every 24 seconds, or about every 8 seconds to about every 12 seconds.

Reference throughout this specification to “one embodiment,” “certain embodiments,” “one or more embodiments” “various embodiments,” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” “in various embodiments,” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A multi-station coater system comprising:
a raw weight station, wherein an initial weight of a substrate is measured;
a first catalytic substrate coating station, wherein a first wet coating comprising a first catalytic coating and a first carrier liquid is introduced into longitudinal cells of the substrate;
a first wet weight station, wherein a first wet weight of the substrate is measured;
a first inline calciner module, wherein a heating fluid is introduced into the substrate to calcine the first catalytic coating at a first calcining temperature; and
a first calcined weight station, wherein a calcined weight of the substrate is measured.

2. The multi-station coater system of claim 1, which further comprises:
a first multi-phase drying station subsequent to the first wet weight station and preceding the first inline calciner module, wherein the first carrier liquid of the first wet coating is at least partially evaporated from the longitudinal cells of the substrate to produce an at least substantially dried substrate having a temperature; and
a first cooling station and a first dry weight station subsequent to the first multi-phase drying station, wherein, at the cooling station, the temperature of the substantially dried substrate decreases, and, at the dry weight station, a first dry weight of the substrate containing the deposited first catalytic coating is measured.

3. The multi-station coater system of claim 2, which further comprises:
a second catalytic substrate coating station, wherein a second wet coating comprising a second catalytic coating and a second carrier liquid is introduced into the longitudinal cells of the substrate;
a second wet weight station, wherein a second wet weight of the substrate is measured after the second wet coating is introduced into the longitudinal cells of the substrate; and
a second multi-phase drying station, wherein the second carrier liquid of the second wet coating is at least partially evaporated from the longitudinal cells of the substrate to produce an at least substantially dried substrate.

4. The multi-station coater system of claim 3, wherein the first wet coating coats a portion of the longitudinal cells of the substrate, the substrate is flipped before the second wet coating is introduced into the longitudinal cells of the substrate, and the second wet coating coats at least a portion of the longitudinal cells of the substrate not coated by the first wet coating.

5. The multi-station coater system of claim 3, which further comprises:
a second cooling station subsequent to the first inline calciner module, wherein the temperature of the substrate decreases to an intermediate temperature between the calcining temperature and room temperature; and
a third cooling station, wherein the temperature of the substrate further decreases from an intermediate temperature to room temperature.

6. The multi-station coater system of claim 5, which further comprises:
a third catalytic substrate coating station subsequent to the third cooling station, wherein a third wet coating comprising a third catalytic coating and a third carrier liquid is introduced into the longitudinal cells of the substrate;
a third wet weight station, wherein a third wet weight of the substrate is measured; and
a third multi-phase drying station subsequent to the third wet weight station, wherein at least a portion of the third carrier liquid of the third wet coating is evaporated from the longitudinal cells of the substrate to produce an at least partially dried substrate.

7. The multi-station coater system of claim 6, which further comprises:
a fourth catalytic substrate coating station, wherein a fourth wet coating comprising a fourth catalytic coating and a fourth carrier liquid is introduced into the substrate;
a fourth wet weight station, wherein a fourth wet weight of the substrate is measured; and a fourth multi-phase drying station subsequent to the fourth wet weight station and preceding the first calciner module, wherein at least a portion of the fourth carrier liquid of the fourth wet coating is evaporated from the longitudinal cells of the substrate to produce an at least partially dried substrate.

8. The multi-station coater system of claim 7, wherein the third wet coating coats a portion of the longitudinal cells of the substrate, the substrate is flipped before the fourth wet coating is introduced into the longitudinal cells of the substrate, and the fourth wet coating coats at least a portion of the longitudinal cells of the substrate not coated by the third wet coating.

9. The multi-station coater system of claim 2, which further comprises a controller in electrical communication with at least the first wet weight station and the first dry weight station, wherein the initial weight of the substrate is compared to the first wet weight of the substrate, and the substrate is not inserted into the first inline calciner module if the difference between the initial weight of the substrate and the wet weight of a substrate is outside of an intended value to avoid calcining an out-of-specification substrate.

10. The multi-station coater system of claim 1, which further comprises:
a loading station, wherein a substrate comprising a plurality of cells is loaded into at least one catalytic substrate coating station; and
a transfer mechanism that moves a substrate sequentially from a preceding modular station to subsequent modular station, wherein a substrate introduced at a loading station is transferred from a preceding modular station to a subsequent modular station in the range of about every 7 to about 10 seconds.

11. A multi-station coater system comprising:
a raw weight station, wherein an initial weight of a substrate is measured;
a first bottom coat station, wherein a first wet coating comprising a first catalytic coating and a first carrier liquid is introduced into longitudinal cells of the substrate;
a first wet weight station, wherein a first wet weight of the substrate is measured;
a first finesse drying station, wherein the carrier liquid of the first wet coating is at least partially evaporated from the longitudinal cells of the substrate to produce an at least partially dried substrate;
a second bottom coat station, wherein a second wet coating comprising a second catalytic coating and a second carrier liquid is introduced into the longitudinal cells of the at least partially dried substrate; a second finesse drying station, wherein the second carrier liquid of the second wet coating is at least partially evaporated from the cells of the substrate to produce an at least partially dried substrate;
a first inline calciner module, wherein a heating fluid is introduced into the substrate to calcine the first and second catalytic coatings; and
a first calcined weight station, wherein a calcined weight of the substrate is measured.

12. The multi-station coater system of claim 11, which further comprises:
a first intermediate drying station subsequent to at least one finesse drying station preceding the first inline calciner module, wherein at least a portion of at least one carrier liquid of at least one wet coating is evaporated from the longitudinal cells of the substrate to produce an at least partially dried substrate;
a second intermediate drying station subsequent to at least one finesse drying station preceding the first inline calciner module, wherein at least a portion of remaining carrier liquid of at least one wet coating is evaporated from the longitudinal cells of the substrate to produce a substantially dry substrate;
a third intermediate drying station subsequent to at least one finesse drying station preceding the first inline calciner module, wherein at least a portion of remaining carrier liquid of at least one wet coating is evaporated from the longitudinal cells of the substrate to produce a dry substrate;
a first final drying station subsequent to the first finesse drying station and preceding the second bottom coat station, wherein remaining carrier liquid of the first wet coating is evaporated from the longitudinal cells of the substrate to produce a dry substrate; and
a second final drying station subsequent to the second finesse drying station and preceding the first inline calciner module, wherein carrier liquid of the second wet coating is evaporated from the longitudinal cells of the substrate to produce a dry substrate.

13. The multi-station coater system of claim 12, which further comprises:
a third catalytic substrate coating station, wherein a third wet coating comprising a third catalytic coating and a third carrier liquid is introduced into the longitudinal cells of the substrate;
a second wet weight station, wherein a wet weight of the substrate is measured;
a third finesse drying station, wherein the carrier liquid of the third wet coating is at least partially evaporated from the longitudinal cells of the substrate to produce an at least partially dried substrate;
a fourth catalytic substrate coating station, wherein a fourth wet coating comprising a fourth catalytic coating and a fourth carrier liquid is introduced into the longitudinal cells of the at least partially dried substrate;
a fourth finesse drying station, wherein the fourth carrier liquid of the fourth wet coating is at least partially evaporated from the longitudinal cells of the substrate to produce an at least partially dried substrate; and
a second inline calciner module, wherein a heating fluid is introduced into the substrate to calcine the third and fourth catalytic coatings.

14. The multi-station coater system of claim 13, which further comprises:
a third intermediate drying station, wherein at least a portion of carrier liquid of any wet coating is evaporated from the longitudinal cells of the substrate to produce an at least partially dried substrate;
a fourth intermediate drying station, wherein at least a portion of remaining carrier liquid of any wet coating is evaporated from the longitudinal cells of the substrate to produce a substantially dry substrate; a third final drying station, wherein remaining carrier liquid of any wet coating is evaporated from the longitudinal cells of the substrate to produce a dry substrate;
a fourth final drying station, wherein carrier liquid of any wet coating is evaporated from the cells of the substrate to produce a dry substrate;
a third inline calciner module, wherein a heating fluid is introduced into the dried substrate to calcine the deposited catalytic coating at a calcining temperature to produce a calcined substrate having a temperature;
a first cooling station, wherein the temperature of the calcined substrate decreases to an intermediate temperature between the calcining temperature and room temperature; and
a second cooling station, wherein the intermediate temperature of the calcined substrate further decreases to room temperature.

15. A modular, multi-station coater system comprising:
a modular raw weight station, wherein an initial weight of a substrate is measured;
at least one modular coating station, wherein a wet coating is introduced into a plurality of cells of the substrate;
at least one wet-weight station, wherein a weight of the substrate having an introduced wet coating is measured; and
at least one modular inline calciner station, wherein the wet coating introduced into the plurality of cells of the substrate is calcined.

16. The modular, multi-station coater system of claim 15, wherein the modular inline calciner station introduces a heating fluid at a temperature in the range of about 350° C. to about 550° C. into the substrate for a time in the range of about 7 seconds to about 15 seconds to calcine the wet coating.

17. The modular, multi-station, coater system of claim 16, which further comprises:
at least one drying station subsequent to the at least one wet-weight station and preceding the at least one modular inline calciner station, wherein the substrate has a temperature and the at least one drying station increases the temperature of the substrate to a temperature of no more than about 210° C. while evaporating a liquid carrier of the wet coating.

18. The modular, multi-station, coater system of claim 16, which further comprises:
at least one modular calcined weight station, wherein a calcined weight of the substrate is measured; and
a transfer mechanism that conveys a substrate sequentially between the modular stations, wherein the modular, multi-station, coater system applies about 350 to about 450 coats per hour and calcines about 350 to about 450 substrates per hour.

19. The modular, multi-station coater system of claim 15, wherein the modular, multi-station coater system produces one calcined substrate having two bottom coats and two top coats about every 8 to about 10 seconds when each station of the modular, multi-station coater system is occupied by a substrate.

20. An apparatus for applying a metered coating to a substrate, which comprises:
a substrate receiving portion comprising a pressure compartment and a containment compartment, wherein the pressure compartment and the containment compartment are configured and dimensioned to fit over a substrate and form a fluid-tight seal with the substrate when in a closed position;
a pressurized gas source, which provides a gas at an adjustable pressure, operatively associated and in fluid communication with the pressure compartment, wherein pressurized gas is delivered to the pressure compartment;
a pressure controller operatively associated with the pressurized gas source that adjusts the pressure of the gas delivered to the pressure compartment; and
a catalytic coating source, which provides a wet coating, operatively associated and in fluid communication with the containment compartment, wherein the wet coating is delivered to the containment compartment.

21. The apparatus of claim 20, which further comprises:
a pressure sensor operatively associated with the pressure compartment and the pressurized gas source that measures gas pressure in the pressure compartment and provides a feedback signal to the pressure controller.

22. The apparatus of claim 20, wherein the pressurized gas source is a compressor, a gas cylinder, or in-house gas line, and the pressure controller is an electronic pressure control valve operatively associated and in fluid communication with the pressurized gas source and pressure compartment.

23. The apparatus of claim 22, wherein the substrate having a plurality of cells and the pressurized gas source provides the gas at a pressure sufficient to support the weight of a column of a slurry having a pre-determined height above each of the plurality of cells.

24. The apparatus of claim 20, wherein the catalytic coating source comprises a catalytic coating reservoir for providing a quantity of wet coating for injection into the containment compartment, a wet coating pump operatively associated and in fluid communication with the coating reservoir, and an injection nozzle operatively associated and in fluid communication with the containment compartment.

25. The apparatus of claim 24, which further comprises a fluid level transducer operatively associated with the containment compartment, wherein the fluid level transducer detects a coating fluid level of the wet coating within the containment compartment.
